(19) United States
(12) Patent Application Publication
(10) Pub. No.: US 2025/0142566 A1
(43) Pub. Date: May 1, 2025

(54) RBW-REDCAP UE CONFIGURED FOR DECODING OVERLAPPING PDSCHS

(71) Applicant: Intel Corporation, Santa Clara, CA (US)

(72) Inventors: Yingyang Li, Beijing (CN); Yi Wang Wang, Beijing (CN); Gang Xiong, Beaverton, OR (US); Debdeep Chatterjee, San Jose, CA (US)

(21) Appl. No.: 18/835,408

(22) PCT Filed: Apr. 19, 2023
(86) PCT No.: PCT/US2023/019071

§ 371 Date: Aug. 2, 2024

Related U.S. Application Data
(60) Provisional application No. 63/411,414, filed on Sep. 29, 2022.
(60) Provisional application No. 63/412,155, filed on Sep. 30, 2022.
(60) Provisional application No. 63/487,536, filed on Feb. 28, 2023.

(30) Foreign Application Priority Data
Apr. 20, 2022 (WO) PCT/CN2022/087830
Apr. 20, 2022 (WO) PCT/US2022/087832

(51) Int. Cl. H04W 72/1273; H04W 72/0446; H04W 72/51; H04W 72/566

(52) U.S. Cl. CPC H04W 72/1273; H04W 72/0446; H04W 72/51; H04W 72/566

(57) ABSTRACT

A UE configured for operating in a 5G NR network may decode signalling that schedules two physical downlink shared channels (PDSCHs) in a same time slot. When the UE is a reduced-bandwidth (RBW) reduced-capacity (RedCap) UE (RBW-RedCap UE), the UE may determine if a total number of allocated PRBs in an OFDM symbol for the two scheduled PDSCHs exceed a predetermined value when the two scheduled PDSCHs either partially or fully overlap in time in non-overlapping PRBs. The UE may also prioritize decoding of one of the two scheduled PDSCHs when the total number of allocated PRBs exceed the predetermined value and when the two scheduled PDSCHs either partially or fully overlap in time in non-overlapping PRBs. If a first of the two scheduled PDSCHs is a unicast PDSCH and a second of the two scheduled PDSCHs is a broadcast PDSCH, the UE may prioritize decoding of the unicast PDSCH.

### PRIORITY CLAIMS

This application claims priority to: International Application No. PCT/CN2022/087830, filed Apr. 20, 2022 [reference number AE3103-PCT-Z]; International Application No. PCT/CN2022/087832, filed Apr. 20, 2022 [reference number AD3164-PCT-Z]; U.S. Provisional Patent Application Ser. No. 63/411,414, filed Sep. 29, 2022 [reference number AE9537-Z]; U.S. Provisional Patent Application Ser. No. 63/412,155, filed Sep. 30, 2022 [reference number AE9607-Z]; and U.S. Provisional Patent Application Ser. No. 63/487,536, filed Feb. 28, 2023 [reference number AF2223-Z], which applications and publication are incorporated herein by reference and made a part hereof.

### TECHNICAL FIELD

Embodiments pertain to wireless communications. Some embodiments relate to wireless networks including 3GPP (Third Generation Partnership Project) and fifth-generation (5G) networks including 5G new radio (NR) (or 5G-NR) networks. Some embodiments relate to sixth-generation (6G) networks. Some embodiments relate to reduced-capacity (RedCap) user equipments (UEs) (RedCap UEs) and some embodiments relate to reduced-bandwidth (RBW) RedCap UEs (RBW-RedCap UEs).

### BACKGROUND

Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

The 5G NR specifications cater to support of a diverse set of verticals and use cases, including enhanced mobile broadband (eMBB) as well as the newly introduced URLLC services. Support for Low Power Wide Area (LPWA) networks and use cases for extremely low complexity/cost devices, targeting extreme coverage and ultra-long battery lifetimes, are expected to be served by MTC (Category M UEs) and NB-IoT (Category NB UEs) technologies.

Through the Rel-17 NR RedCap work item, 3GPP has established a framework for enabling reduced capability NR devices suitable for a range of use cases, including the industrial sensors, video surveillance, and wearables use cases, with requirements on low UE complexity and sometimes also on low UE power consumption. Now when the foundation has been laid in Rel-17, enhancements can be considered to improve the support for the mentioned use cases and also to expand RedCap into a new range of use cases such as smart grid.

To further expand the market for RedCap use cases with lower cost/complexity, lower energy consumption, and lower data rate requirements, e.g., industrial wireless sensor network use cases, some further complexity reduction enhancements should be considered for Rel-18 RedCap UE. One potential enhancement to reduce cost is to reduce the bandwidth for Rel-18 RedCap UE.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIGS. 1D, 1E and 1F illustrate some bandwidth options for RedCap UEs, in accordance with some embodiments.

FIGS. 2A and 2B illustrate two broadcast PDSCHs, in accordance with some embodiments.

FIGS. 3A and 3B illustrate one broadcast PDSCH and one unicast PDSCH, in accordance with some embodiments.

FIG. 4 illustrates one broadcast PDSCH and one unicast PDSCH, in accordance with some embodiments.

FIGS. 5A, 5B, 5C and 5D illustrate reception of an SSB and one unicast PDSCH, in accordance with some embodiments.

FIGS. 6A and 6B illustrate reception of a CORESET and a unicast PDSCH, in accordance with some embodiments.

FIGS. 7A and 7B illustrate reception of a CSI-RS and a unicast PDSCH, in accordance with some embodiments.

FIG. 8 illustrates a frequency region with localized PRBs and FDRA, in accordance with some embodiments.

FIG. 9A illustrates FDRA with a heady for frequency region in indication, in accordance with some embodiments.

FIG. 9B illustrates two partial RBG in the frequency region of 25 PRBs, in accordance with some embodiments.

FIG. 9C illustrates a single partial RBG in the frequency region of PRBs, in accordance with some embodiments.

FIG. 10 illustrates a frequency region with distributed PRBs and FDRA, in accordance with some embodiments.

FIG. 11 illustrates frequency hopping between different frequency regions, in accordance with some embodiments.

FIG. 12 illustrates frequency hopping with a same FDRA in each frequency region, in accordance with some embodiments.

FIG. 13 illustrates frequency hopping across frequency regions with a second hop spanning two adjacent frequency regions, in accordance with some embodiments.

FIG. 14 illustrates a functional block diagram of a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to a user equipment (UE) configured for operating in a fifth-generation (5G) new radio (NR) network. In these embodiments, the UE may decode signalling that schedules two physical downlink shared channels (PDSCHs) in a same time slot. In these embodiments, when the UE is a reduced-bandwidth (RBW) reduced-capacity (RedCap) UE (RBW-RedCap UE), the UE may determine if a total number of allocated physical resource blocks (PRBs) in an OFDM symbol for the two scheduled PDSCHs exceed a predetermined value (e.g., NBWPRBs) when the two scheduled PDSCHs either partially or fully overlap in time in non-overlapping PRBs. The UE may also prioritize decoding of one of the two scheduled PDSCHs when the total number of allocated PRBs exceed the predetermined value and when the two scheduled PDSCHs either partially or fully overlap in time in non-overlapping PRBs. If a first of the two scheduled PDSCHs is a unicast PDSCH and a second of the two scheduled PDSCHs is a broadcast PDSCH, the UE may prioritize decoding of the unicast PDSCH, although the scope of the embodiments is not limited in this respect. These embodiments as well as others, are described in more detail below.

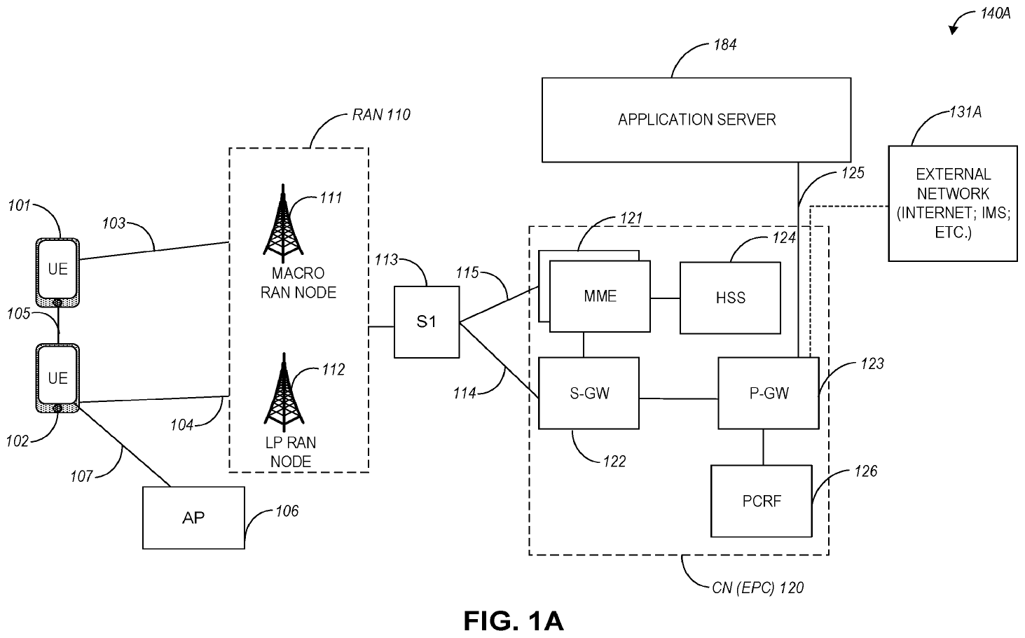

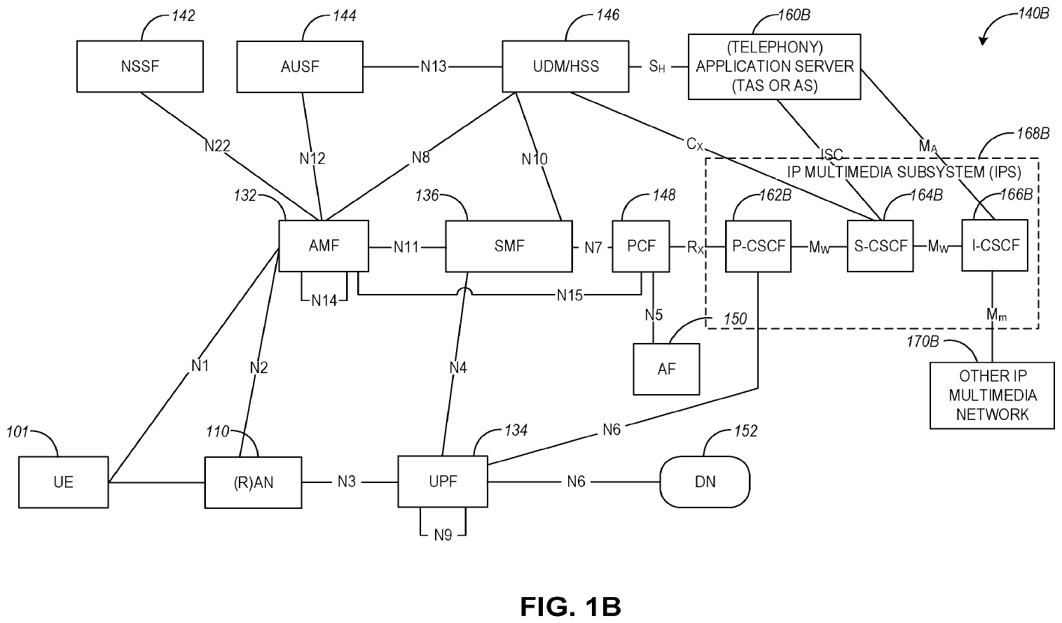

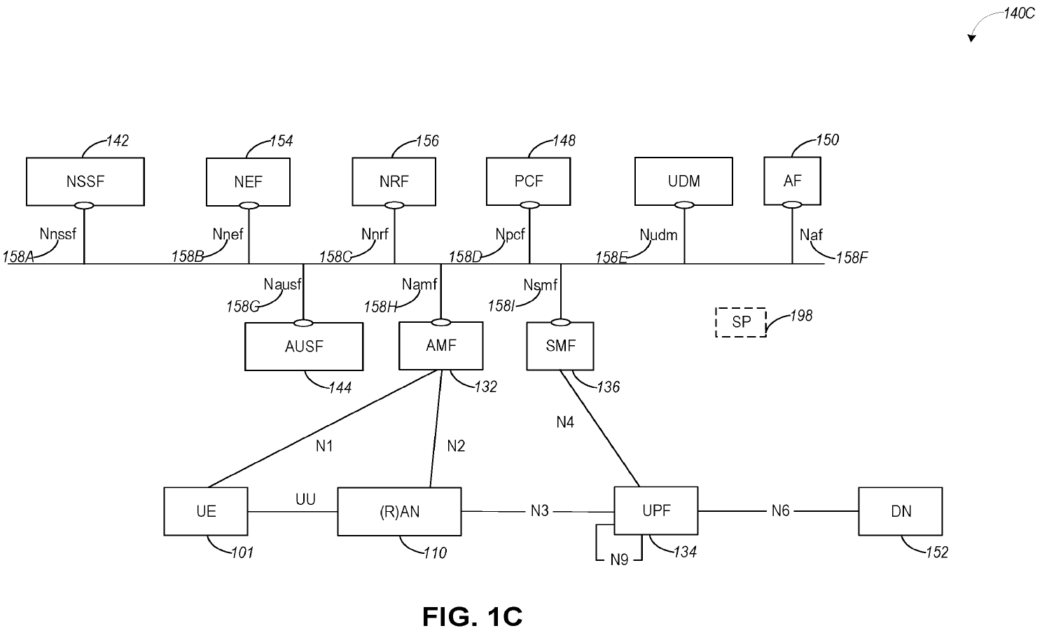

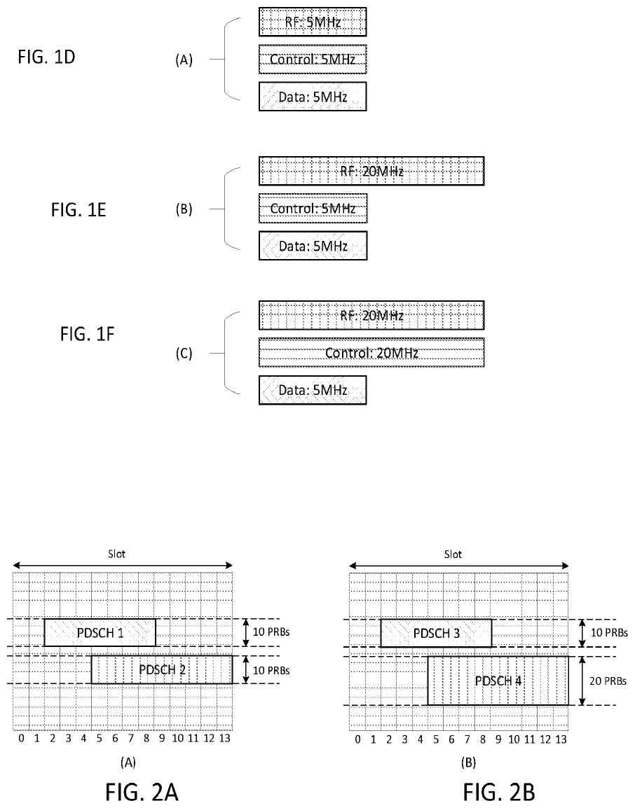

FIG. 1A illustrates an architecture of a network in accordance with some embodiments. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UEs 101 and 102 can comprise an Internet-of-Things (IoT) UE or a Cellular IoT (CIoT) UE, which can comprise a network access layer designed for low-power IoT applications utilizing short-lived UE connections. In some embodiments, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the nodes 111 and 112 can be transmission/reception points (TRPs). In instances when the nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node, and one or more RAN nodes for providing femtocells or picocells (e.g., cells having smaller coverage areas, smaller user capacity, or higher bandwidth compared to macrocells), e.g., low power (LP) RAN node.

Any of the RAN nodes can terminate the air interface protocol and can be the first point of contact for the UEs 101 and 102. In some embodiments, any of the nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the nodes 111 and 112 and the serving gateway (S-GW) 122, and the S1-mobility management entity (MME) interface 115, which is a signaling interface between the nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the a RAN node (node 110) and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

FIGS. 1D, 1E and 1F illustrate some bandwidth options for RedCap UEs, in accordance with some embodiments. These examples of bandwidth options are for RBW-RedCap UEs referred to as Reduced Bandwidth-RedCap (RBW-RedCap) UEs. In FIG. 1D, both radio frequency (RF) and baseband (BB) can be reduced to 5 MHz which maximize potential complexity reduction. In FIG. 1E, the BB is reduced to 5 MHz while the RF is still 20 MHz since the complexity reduction by BW reduction of RF is not significant. In FIG. 1F, it keeps both the RF and control channel/signal in the BB as 5 MHz and only the data channel in BB can be reduced to 5 MHz. Though FIG. 1F provides the least complexity reduction, it allows more flexible scheduling which minimize the changes to existing NR operations.

Due to the reduced BW of 5 MHz for RF and/or BB, it imposes a limitation on the DL transmissions. Disclosed herein are enhancements to receive multiple overlapped DL channels for UE with reduced bandwidth are presented. In particular:
Two broadcast PDSCHs in a slot
One unicast PDSCH+one broadcast PDSCH in a slot
Maximum number of PDSCHs under processing
PDSCH and SSB, CORESET or CSI-RS in same slot

In order to reduce the cost, further reduction of bandwidth at least for data channel of the baseband (BB) processing can be considered for the RBW-RedCap UE. Consequently, the complexity of the post-FFT data buffer, receiver processing block, LDPC decoding and HARQ buffer can be reduced. On the other hand, due to the reduced BW of 5 MHz for at least PDSCH for the RBW-RedCap UE, it imposes a limitation to receive multiple DL transmissions in same OFDM symbol or same slot. For a RBW-RedCap UE, the reduced capability can be defined in different ways.

In one option, a RBW-RedCap UE may be only capable of processing up to N_{BW} localized PRBs. For example, N_{BW} equals to 25 which corresponds to 5 MHz bandwidth as shown in FIG. 1D and FIG. 1E. In another example, for FIG. 1F, the N_{BW} localized PRBs may have multiple possible locations within the DL/UL BWP or no limitation on the location of the N_{BW} PRBs within the DL/UL BWP.

In another option, a RBW-RedCap UE may be only capable of processing up to N_{BW} PRBs in the DL or UL BWP of up to 20 MHz. It is not limited that the N_{BW} PRBs are localized or distributed. For FIG> 1F, the N_{BW} PRBs may have multiple possible locations within the DL/UL BWP or no limitation on the location of the N_{BW} PRBs within the DL/UL BWP.

In another option, the maximum number of REs in a slot that can be processed by a RBW-RedCap UE is limited to no more than a threshold. The maximum number of REs may only include the REs of the PDSCH or PUSCH transmission(s) in a slot. Alternatively, the maximum number of REs may include the REs of the PDSCH transmission(s) in a slot and one or more other channels/signals in the slot, e.g., SSB, CORESET and/or CSI-RS. Alternatively, the maximum number of REs may include the REs of the PUSCH transmission(s) in a slot and one or more other channels/signals in the slot, e.g. PUCCH and/or SRS. The threshold may be N_{RE} or 12·N_{BW}·N_{sym}, REs. N_{RE} is the maximum number of REs per slot that can be processed by the UE. N_{sym} is a number of OFDM symbols used to determine a maximum number of REs per slot that can be processed by the UE. N_{RE} or N_{sym} may be predefined, e.g., N_{sym}=11 assuming 3 symbols may be used for PDCCH. In the above options, the threshold can be same or different for DL or UL transmission.

In another option, the sum of TBSs of multiple PDSCHs or PUSCHs in a slot is limited to be no more than a maximum value. Alternatively, the sum of multiple PDSCHs or PUSCHs in a slot is limited to be no more than a maximum data rate.

Some embodiments are directed to a user equipment (UE) configured for operating in a fifth-generation (5G) new radio (NR) network. In these embodiments, the UE may decode signalling that schedules two physical downlink shared channels (PDSCHs) in a same time slot. In these embodiments, when the UE is a reduced-bandwidth (RBW) reduced-capacity (RedCap) UE (RBW-RedCap UE), the UE may determine if a total number of allocated physical resource blocks (PRBs) in an OFDM symbol for the two scheduled PDSCHs exceed a predetermined value (e.g., N_{BW}PRBs) when the two scheduled PDSCHs either partially or fully overlap in time in non-overlapping PRBs. The UE may also prioritize decoding of one of the two scheduled PDSCHs when the total number of allocated PRBs exceed the predetermined value and when the two scheduled PDSCHs either partially or fully overlap in time in non-overlapping PRBs. If a first of the two scheduled PDSCHs is a unicast PDSCH and a second of the two scheduled PDSCHs is a broadcast PDSCH, the UE may prioritize decoding of the unicast PDSCH, although the scope of the embodiments is not limited in this respect.

FIGS. 2A and 2B, FIGS. 3A and 3B, and FIG. 4 illustrate two physical downlink shared channels (PDSCHs) in a same time slot. In some of these embodiments, a RBW-RedCap UE does not expect to decode two PDSCHs that partially or fully overlap in time in non-overlapping PRBs if the total number of allocated PRBs of the two PDSCHs in any OFDM symbol exceeds N_{BW} PRBs. In some of these embodiments, a RBW-RedCap UE does not expect to decode two PDSCHs in the same slot if the total number of allocated PRBs of the two PDSCHs in any one OFDM symbol exceeds N_{BW} PRBs. These embodiments as well as others are described in more detail below.

In some embodiments, the predetermined value (e.g., N_{BW}PRBs) is twenty-five (25) for a subcarrier spacing (SCS) of 15 kHz. In these embodiments, a RBW-RedCap UE may not have the capability to decode two PDSCHs if the total number of allocated PRBs in any one OFDM symbol exceed 25 PRBs, although the scope of the embodiments is not limited in this respect.

In some embodiments, for a RBW-RedCap UE, the UE may decode both of the two scheduled PDSCHs when the total number of allocated PRBs does not exceed the predetermined value although the scope of the embodiments is not limited in this respect. In some embodiments, for a RBW-RedCap UE, the UE may decode both of the two scheduled PDSCHs or when the two scheduled PDSCHs are not partially or fully overlapping in time in non-overlapping PRBs.

In some embodiments, a first of the two scheduled PDSCHs is a unicast PDSCH and a second of the two scheduled PDSCHs is a broadcast PDSCH. In these embodiments, the UE may be configured to prioritize decoding of the unicast PDSCH when the total number of allocated PRBs exceeds the predetermined value and when the two scheduled PDSCHs either partially or fully overlap in time in non-overlapping PRBs. In these embodiments, decoding of a unicast PDSCH may be prioritized since there may be a timeline requirement (e.g., to report HARQ-ACK feedback). On the other hand, a broadcast PDSCH (e.g., SIB1/OSI/paging) may not have such a timeline requirement and therefore decoding is less urgent.

In some embodiments, when the second of the two scheduled PDSCHs is scheduled with a Random-Access RNTI (RA-RNTI) (i.e., a broadcast PDSCH), the UE may prioritize decoding of the PDSCH scheduled with the RA-RNTI over the unicast PDSCH. In these embodiments, the broadcast PDSCH may be prioritized over a unicast PDSCH, although the scope of the embodiments is not limited in this respect. In these embodiments, the RA-RNTI schedules a special broadcast PDSCH that will schedule msg3 for transmission by the UE by a random-access response (RAR). Since there is a required timeline for the random-access response (RAR), the RAR may be more important than a unicast PDSCH and should be prioritized over other PDSCHs including a unicast PDSCH, although the scope of the embodiments is not limited in this respect.

In some embodiments, the signalling that schedules the two PDSCHs may comprise Radio Network Temporary Identifiers (RNTIs). In these embodiments, the UE may determine which one of the two scheduled PDSCHs to prioritize decoding based on the RNTI.

In some embodiments, the UE may prioritize the decoding of one of the two scheduled PDSCHs that is scheduled with a Cell-RNTI (C-RNTI), a Modulation Coding Scheme C-RNTI (MCS-C-RNTI), or a Configured Scheduling RNTI (CS-RNTI) (i.e., unicast PDSCHs) over decoding of one of the two scheduled PDSCHs that is scheduled with a System Information RNTI (SI-RNTI), a Paging RNTI (P-RNTI) or a temporary C-RNTI (TC-RNTI) (i.e., broadcast PDSCHs), although the scope of the embodiments is not limited in this respect.

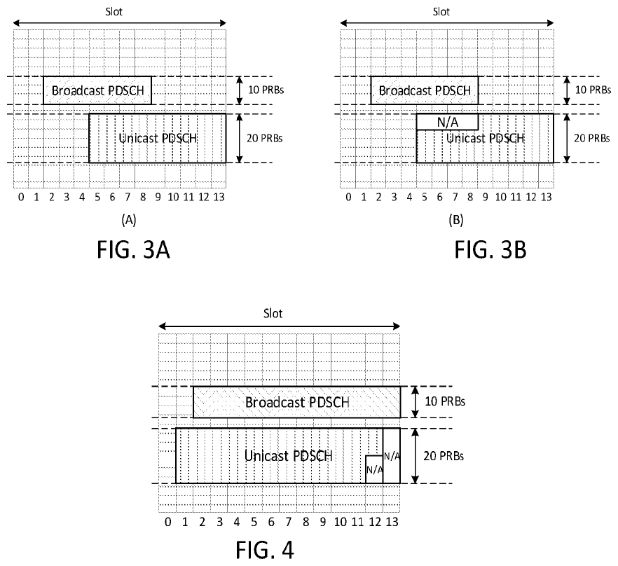

In some embodiments, when the UE is a RBW-RedCap UE and when the UE prioritizes decoding of the first of the two scheduled PDSCHs, the UE may process a first number of PRBs that are allocated to the first of the two scheduled PDSCHs, and process a subset of a second number of PRBs that are allocated to the second of the two scheduled PDSCH up to the predetermined value. In these embodiments, the first number of PRBs and the subset of the second number of PRBs is that are processed may be less than or equal to the predetermined value (e.g., N_{BW}PRBs). In these embodiments, a RBW-RedCap UE may not have the capability to decode two PDSCHs if they exceed the predetermined value. An example of this is illustrated in FIG. 3B. In some embodiments, when the UE prioritizes decoding of one of the two scheduled PDSCHs, the UE may be configured to drop the other PDSCH, although the scope of the embodiments is not limited in this respect.

In some embodiments, when the UE is a RBW-RedCap UE and is configured to meet a preconfigured PDSCH decoding timeline, the UE may prioritize decoding of one of the two scheduled PDSCHs when the total number of allocated PRBs exceed the predetermined value and when the two scheduled PDSCHs either partially or fully overlap in time in non-overlapping PRBs. In these embodiments, when the UE is a RBW-RedCap UE and is not configured to meet a preconfigured PDSCH decoding timeline (e.g., the decoding timeline is relaxed), the UE may not be configured to prioritize decoding of one of the two scheduled PDSCHs when the total number of allocated PRBs exceed the predetermined value.

In these embodiments, when the UE is a RBW-RedCap UE and the PDSCH decoding timeline is relaxed, the UE may decode both of the two scheduled PDSCHs even though the total number of allocated PRBs may exceed the predetermined value. In these embodiments, the decoding timeline may refer to a time within which the PDSCH needs to be decoded in accordance with the 3GPP standards.

In some embodiments, when the UE is a RBW-RedCap UE and is configured to meet a preconfigured PDSCH decoding timeline, the UE may prioritize decoding of one of the two scheduled PDSCHs when the total number of allocated PRBs exceed the predetermined value and when the two scheduled PDSCHs either partially or fully overlap in time in non-overlapping PRBs. When the UE is a RBW-RedCap UE and the PDSCH decoding timeline is relaxed, the UE may decode one of the two scheduled PDSCHs when the two PDSCHs are scheduled in different slots and the total number of allocated PRBs exceeds the predetermined value.

In some embodiments, when the UE is a RBW-RedCap UE, the UE may have a maximum operating bandwidth of 20 MHz for frequency range one (FR1) and 100 MHz for FR2 and may be capable of reception of scheduled unicast PDSCHs with a total number of PRBs up to the predetermined value (e.g., N_{BW}PRBs).

In some embodiments, for a broadcast PDSCH up to 20 MHz, a RBW-RedCap UE may have the capability to decode up to 106 PRBs in a longer timeframe. A non-RBW-RedCap UE, on the other hand may have a maximum operating bandwidth of 100 MHz or more for FR1 and 200 MHz or more for FR2 and capable of reception of PDSCHs scheduled with a total number of PRBs that exceed the predetermined value.

In some embodiments, when at least one of the two scheduled PDSCHs is a broadcast PDSCH and when the UE is not a RBW-RedCap UE, the UE may decode both of the scheduled PDSCHs regardless of whether the total number of allocated PRBs exceed the predetermined value or whether the two scheduled PDSCHs either partially or fully overlap.

In some embodiments, the UE may include processing circuitry which may comprise a baseband processor. The UE may also include memory configured to store a value representing the total number of allocated PRBs.

Some embodiments are directed to a non-transitory computer-readable storage medium that stores instructions for execution by processing circuitry of a user equipment (UE) configured for operating in a fifth-generation (5G) new radio (NR_network. In these embodiments, the processing circuitry may be configured to decode signalling that schedules two physical downlink shared channels (PDSCHs) in a same time slot. In these embodiments, when the UE is a reduced-bandwidth (RBW) reduced-capacity (RedCap) UE (RBW-RedCap UE), the processing circuitry may be configured to determine if a total number of allocated physical resource blocks (PRBs) in an OFDM symbol for the two scheduled PDSCHs exceed a predetermined value (e.g., N_{BW}PRBs) when the two scheduled PDSCHs either partially or fully overlap in time in non-overlapping PRBs. The processing circuitry may also prioritize decoding of one of the two scheduled PDSCHs when the total number of allocated PRBs exceed the predetermined value and when the two scheduled PDSCHs either partially or fully overlap in time in non-overlapping PRBs.

Some embodiments are directed to a method performed by processing circuitry of a user equipment (UE) configured for operating in a fifth-generation (5G) new radio (NR) network. The method may comprise decoding signalling that schedules two physical downlink shared channels (PDSCHs) in a same time slot. When the UE is a reduced-bandwidth (RBW) reduced-capacity (RedCap) UE (RBW-RedCap UE), the method comprises determining if a total number of allocated physical resource blocks (PRBs) in an OFDM symbol for the two scheduled PDSCHs exceed a predetermined value (e.g., N_{BW}PRBs) when the two scheduled PDSCHs either partially or fully overlap in time in non-overlapping PRBs. The method may also comprise prioritizing decoding of one of the two scheduled PDSCHs when the total number of allocated PRBs exceed the predetermined value and when the two scheduled PDSCHs either partially or fully overlap in time in non-overlapping PRBs.

### Two Broadcast PDSCHs in a Slot

According to the existing NR specifications, a UE supports simultaneous receptions of partially or fully time-overlapping broadcast PDSCHs in RRC_IDLE and RRC_INACTIVE states. For an RBW-RedCap UE in idle or inactive state, due to low processing capability, certain relaxations may be defined to the decoding of PDSCH(s) scheduled with S1-RNTI, P-RNTI, RA-RNTI or TC-RNTI.

FIGS. 2A and 2B illustrate two broadcast PDSCHs, in accordance with some embodiments. FIGS. 2A and 2B illustrate two examples for two broadcast PDSCHs allocated in one slot. It is assumed PDSCH 1, 2 & 3 have respectively 10 PRBs, while PDSCH 4 has 20 PRBs. PDSCH 1 & 2 are overlapped in time, while PDSCH 3 & 4 are overlapped in time. Note: localized PRB allocation are assumed for each PDSCH, though it may be allowed to schedule distributed PRBs for each PDSCH.

In one embodiment, an RBW-RedCap UE does not expect that the number of allocated PRBs of a PDSCH exceeds N_{BW} PRBs. Alternatively, if the number of allocated PRBs of a PDSCH can be larger than N_{BW}, the PDSCH decoding timeline can be relaxed. The following options can be considered to handle the multiple PDSCH(s) scheduled with SI-RNTI, P-RNTI, RA-RNTI or TC-RNTI in the same slot. In this embodiment, when a UE needs to decode two PDSCHs in a slot, the two PDSCHs may be just scheduled in the slot. Alternatively, the two PDSCHs may be scheduled in different slots, however, due to the relaxed decoding timeline of one PDSCH, the decoding of the two PDSCH overlap in the slot. If the two PDSCHs are scheduled in the same slot, the two PDSCHs may be partially or fully overlapping in time in non-overlapping PRBs. If the two PDSCHs are scheduled in the different slots, the two PDSCHs may be scheduled in overlapping or non-overlapping PRBs.

In one option, in idle or inactive state, an RBW-RedCap UE may be expected to decode two PDSCHs each scheduled with SI-RNTI, P-RNTI, RA-RNTI or TC-RNTI, with the two PDSCHs partially or fully overlapping in time in non-overlapping PRBs, if the total number of allocated PRBs of the two PDSCHs in any OFDM symbol does not exceed N_{BW} PRBs. With this option, in FIG. 2A, since the total number of RPBs for broadcast PDSCH 1 & 2 in any OFDM symbol is no more than N_{BW}=25, both two PDSCHs can be decoded by the RBW-RedCap UE. On the other hand, in FIG. 2B, since the total number of RPBs for broadcast PDSCH 3 & 4 in OFDM symbol 5/6/7/8 is 30 which exceed N_{BW}, PDSCH 3 & 4 are not valid scheduling/configuration for the RBW-RedCap UE.

In another option, in idle or inactive state, an RBW-RedCap UE may be expected to decode two PDSCHs in the same slot, each scheduled with SI-RNTI, P-RNTI, RA-RNTI or TC-RNTI, if the total number of allocated PRBs of the two PDSCHs in any OFDM symbol does not exceed N_{BW} PRBs.

In one option, in idle or inactive state, if an RBW-RedCap UE would decode the two PDSCHs each scheduled with SI-RNTI, P-RNTI, RA-RNTI or TC-RNTI, and the total number of allocated PRBs of the two PDSCHs in any OFDM symbol exceeds N_{BW} PRBs, the UE may prioritize the reception of one of the two PDSCHs. For example, the UE may only decode one of the two PDSCHs in a time. A de-prioritized PDSCH can be decoded after the decode of a prioritized PDSCH is completed or if the prioritized PDSCH is not received yet. The prioritized PDSCH may be determined by the RNTI. For example, the PDSCH scheduled by RA-RNTI is prioritized for scheduling of msg3.

In one option, in idle or inactive state, if an RBW-RedCap UE would decode two PDSCHs each scheduled with SI-RNTI, P-RNTI, RA-RNTI or TC-RNTI, with the two PDSCHs partially or fully overlapping in time in non-overlapping PRBs, and the total number of allocated PRBs of the two PDSCHs in any OFDM symbol exceeds N_{BW} PRBs, the UE may only decode one of the two PDSCHs. The other PDSCH is dropped. The prioritized PDSCH may be determined by the RNTI.

In another option, in idle or inactive state, if an RBW-RedCap UE would decode two PDSCHs in a slot, each scheduled with SI-RNTI, P-RNTI, RA-RNTI or TC-RNTI, and the total number of allocated PRBs of the two PDSCHs in any OFDM symbol exceeds N_{BW} PRBs, the UE may only decode one of the two PDSCHs. The other PDSCH is dropped. The prioritized PDSCH may be determined by the RNTI.

In one option, in idle or inactive state, an RBW-RedCap UE does not expect to decode two PDSCHs each scheduled with SI-RNTI, P-RNTI, RA-RNTI or TC-RNTI, with the two PDSCHs partially or fully overlapping in time in non-overlapping PRBs, if the total number of allocated PRBs of the two PDSCHs in any OFDM symbol exceeds N_{BW} PRBs.

In another option, in idle or inactive state, an RBW-RedCap UE does not expect to decode two PDSCHs in the same slot, each scheduled with SI-RNTI, P-RNTI, RA-RNTI or TC-RNTI, if the total number of allocated PRBs of the two PDSCHs in any OFDM symbol exceeds N_{BW} PRBs.

In one embodiment, an RBW-RedCap UE does not expect that the allocated PRBs of a PDSCH span more than N_{BW} localized PRBs. The following options can be considered to handle the multiple PDSCH(s) scheduled with SI-RNTI, P-RNTI, RA-RNTI or TC-RNTI in the same slot.

In one option, in idle or inactive state, an RBW-RedCap UE may be expected to decode two PDSCHs each scheduled with SI-RNTI, P-RNTI, RA-RNTI or TC-RNTI, with the two PDSCHs partially or fully overlapping in time in non-overlapping PRBs, if the two PDSCHs are allocated within Now localized PRBs.

In another option, in idle or inactive state, an RBW-RedCap Cap UE may be expected to decode two PDSCHs in the same slot, each scheduled with SI-RNTI, P-RNTI, RA-RNTI or TC-RNTI, if the two PDSCHs are allocated within N_{BW} localized PRBs.

In one option, in idle or inactive state, if an RBW-RedCap UE would decode two PDSCHs each scheduled with SI-RNTI, P-RNTI, RA-RNTI or TC-RNTI, with the two PDSCHs partially or fully overlapping in time in non-overlapping PRBs, and the two PDSCHs are not allocated within N_{BW} localized PRBs, the UE may only decode one of the two PDSCHs. The prioritized PDSCH may be determined by the RNTI.

In another option, in idle or inactive state, if an RBW-RedCap Cap UE would decode two PDSCHs in the same slot, each scheduled with SI-RNTI, P-RNTI, RA-RNTI or TC-RNTI, and the two PDSCHs are not allocated within N_{BW} localized PRBs, the UE may only decode one of the two PDSCHs. The prioritized PDSCH may be determined by the RNTI.

In one option, in idle or inactive state, an RBW-RedCap UE does not expect to decode two PDSCHs each scheduled with SI-RNTI, P-RNTI, RA-RNTI or TC-RNTI, with the two PDSCHs partially or fully overlapping in time in non-overlapping PRBs, if the two PDSCHs are not allocated within N_{BW} localized PRBs.

In another option, in idle or inactive state, an RBW-RedCap Cap UE does not expect to decode two PDSCHs in the same slot, each scheduled with SI-RNTI, P-RNTI, RA-RNTI or TC-RNTI, if the two PDSCHs are not allocated within N_{BW} localized PRBs.

In another embodiment, a RBW-RedCap UE does not expect that the number of allocated REs of a PDSCH exceeds a maximum number of N_{RE} or 12·N_{BW}·N_{sym} REs in a slot. The following options can be considered to handle the multiple PDSCH(s) scheduled with SI-RNTI, P-RNTI, RA-RNTI or TC-RNTI in the same slot.

In one option, in idle or inactive state, a RBW-RedCap UE may be expected to decode two PDSCHs each scheduled with SI-RNTI, P-RNTI, RA-RNTI or TC-RNTI, with the two PDSCHs partially or fully overlapping in time in non-overlapping PRBs, if the total number of allocated REs of the two PDSCHs in a slot does not exceed N_{RE} or 12·N_{BW}·N_{BW} REs. With this option, the broadcast PDSCH 1 & 2 in FIG. 2A can still be decoded by the RBW-RedCap UE. On the other hand, in FIG. 2B, since the total number of REs for broadcast PDSCH 3 & 4 is less than the limit e.g., 12·N_{BW}·N_{sym} where N_{BW} may be 25 and N_{sym} may equal to 14, the RBW-RedCap UE can decode PDSCH 3& 4.

In another option, in idle or inactive state, a RBW-RedCap UE can decode two PDSCHs in the same slot each scheduled with SI-RNTI, P-RNTI, RA-RNTI or TC-RNTI, if the total number of allocated REs of the two PDSCHs in a slot does not exceed N_{RE} or 12·N_{BW}·N_{sym} REs.

In one option, in idle or inactive state, if a RBW-RedCap UE would decode two PDSCHs each scheduled with SI-RNTI, P-RNTI, RA-RNTI or TC-RNTI, with the two PDSCHs partially or fully overlapping in time in non-overlapping PRBs, and the total number of allocated REs of the two PDSCHs in a slot exceeds N_{RE} or 12·N_{BW}·N_{sym} REs, the UE may only decode one of the two PDSCHs. The prioritized PDSCH may be determined by the RNTI.

In another option, in idle or inactive state, if a RBW-RedCap UE would decode two PDSCHs in the same slot each scheduled with SI-RNTI, P-RNTI, RA-RNTI or TC-RNTI, and the total number of allocated REs of the two PDSCHs in a slot exceeds N_{RE} or 12·N_{BW}·N_{sym} REs, the UE may only decode one of the two PDSCHs. The prioritized PDSCH may be determined by the RNTI.

In one option, in idle or inactive state, a RBW-RedCap UE does not expect to decode two PDSCHs each scheduled with SI-RNTI, P-RNTI, RA-RNTI or TC-RNTI, with the two PDSCHs partially or fully overlapping in time in non-overlapping PRBs, if the total number of allocated REs of the two PDSCHs in a slot exceeds N_{RE} or 12·N_{BW}·N_{sym} REs.

In another option, in idle or inactive state, a RBW-RedCap UE does not expect to decode two PDSCHs in the same slot each scheduled with SI-RNTI, P-RNTI, RA-RNTI or TC-RNTI, if the total number of allocated REs of the two PDSCHs in a slot exceeds N_{RE} or 12·N_{BW}·N_{sym} REs.

In one embodiment, an RBW-RedCap UE does not expect that the sum of the TBSs of multiple PDSCH(s) scheduled with SI-RNTI, P-RNTI, RA-RNTI or TC-RNTI in the same slot is larger than a threshold T. T can be predefined or reported as UE capability.

In one embodiment, an RBW-RedCap UE does not expect that the sum of multiple PDSCH(s) scheduled with SI-RNTI, P-RNTI, RA-RNTI or TC-RNTI in the same slot exceeds a maximum data rate. The maximum data rate can be predefined or reported as UE capability. For example, as defined in TS 38.306

$$data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \frac{{N}_{PRB}^{BW ( j ) , μ} \cdot 12}{{T}_{s}^{μ}} ( 1 - {OH}^{\text{?}} \text{?}$$

$$\text{?} \text{indicates text missing or illegible when filed}$$

The parameters in the formula may be set based on the characteristic of the RBW-RedCap UE.

In one embodiment, in idle or inactive state, an RBW-RedCap UE does not expect to decode more than one PDSCH scheduled with SI-RNTI, P-RNTI, RA-RNTI or TC-RNTI in a OFDM symbol. With this option, both two examples in FIGS. 2A and 2B are invalid scheduling/configuration.

In one embodiment, in idle or inactive state, an RBW-RedCap UE does not expect to decode more than PDSCH scheduled with SI-RNTI, P-RNTI, RA-RNTI or TC-RNTI in a slot.

### One Unicast PDSCH+One Broadcast PDSCH in a Slot

According to the existing NR specifications, a UE is expected to be able to decode a unicast PDSCH and a broadcast PDSCH for system information when the two PDSCH are partially or fully overlapping in time in non-overlapping PRBs. For a RBW-RedCap UE, due to low processing capability, certain relaxations may be defined to the decoding of a PDSCH scheduled with C-RNTI, MCS-C-RNTI, or CS-RNTI and, for P-RNTI triggered or autonomous SI acquisition, another PDSCH scheduled with SI-RNTI in the same slot.

FIGS. 3A and 3B illustrate one broadcast PDSCH and one unicast PDSCH, in accordance with some embodiments. FIGS. 3A and 3B illustrate two examples for one broadcast PDSCH plus one unicast PDSCH that are allocated and overlapped in one slot. It is assumed the broadcast PDSCH has 10 PRB and the unicast PDSCH has 20 PRBs. The two PDSCHs are overlapped in time. Note: localized PRB allocation are assumed for each PDSCH, though it may be allowed to schedule distributed PRBs for each PDSCH.

In one embodiment, an RBW-RedCap UE does not expect that the number of allocated PRBs of a PDSCH exceeds N_{BW} PRBs, e.g., the PDSCH scheduled with C-RNTI, MCS-C-RNTI, or CS-RNTI. Alternatively, if the number of allocated PRBs of a PDSCH can be larger than N_{BW}, the PDSCH decoding timeline can be relaxed. Such PDSCH may be a PDSCH of a P-RNTI triggered SI acquisition, or other PDSCH scheduled with SI-RNTI, P-RNTI, RA-RNTI or TC-RNTI. The following options can be considered to handle a PDSCH scheduled with C-RNTI, MCS-C-RNTI, or CS-RNTI and, for P-RNTI triggered or autonomous SI acquisition, another PDSCH scheduled with SI-RNTI in the same slot. The above another PDSCH can be replaced by a PDSCH scheduled with SI-RNTI, P-RNTI, RA-RNTI or TC-RNTI too. In this embodiment, when a UE needs to decode two PDSCHs in a slot, the two PDSCHs may be just scheduled in the slot. Alternatively, the two PDSCHs may be scheduled in different slots, however, due to the relaxed decoding timeline of one PDSCH, the decoding of the two PDSCH overlap in the slot. If the two PDSCHs are scheduled in the same slot, the two PDSCHs may be partially or fully overlapping in time in non-overlapping PRBs. If the two PDSCHs are scheduled in the different slots, the two PDSCHs may be scheduled in overlapping or non-overlapping PRBs.

In one option, a RBW-RedCap UE may be expected to decode the two PDSCHs if the total number of allocated PRBs of the two PDSCHs does not exceed N_{BW} PRBs. Otherwise, the RBW-RedCap UE may prioritize the reception of one of the two PDSCHs. For example, the UE may only decode one of the two PDSCHs. A de-prioritized PDSCH can be decoded after the decode of a prioritized PDSCH is completed or if the prioritized PDSCH is not received yet. The prioritized PDSCH may be determined by the RNTI. For example, the UE may prioritize the PDSCH scheduled with C-RNTI, MCS-C-RNTI, or CS-RNTI.

In one option, a RBW-RedCap UE may be expected to decode the two PDSCHs that partially or fully overlap in time in non-overlapping PRBs, if the total number of allocated PRBs of the two PDSCHs does not exceed N_{BW} PRBs. Otherwise, the RBW-RedCap UE may only decode one of the two PDSCHs. The other PDSCH is dropped. The prioritized PDSCH may be determined by the RNTI. For example, the UE may receive the PDSCH scheduled with C-RNTI, MCS-C-RNTI, or CS-RNTI. With this option, in FIG. 3A, since the total number of RPBs for the two PDSCHs in OFDM symbol 5/6/7/8 is 30 which exceed N_{BW}, the two PDSCHs are not valid scheduling/configuration for the RBW-RedCap UE. The RBW-RedCap UE may drop the broadcast PDSCH.

In another option, a RBW-RedCap UE may be expected to decode the two PDSCHs in a slot, if the total number of allocated PRBs of the two PDSCHs in any OFDM symbol does not exceed N_{BW} PRBs. Otherwise, the RBW-RedCap UE may only decode one of the two PDSCHs. The other PDSCH is dropped. The prioritized PDSCH may be determined by the RNTI. For example, the UE may receive the PDSCH scheduled with C-RNTI, MCS-C-RNTI, or CS-RNTI.

In another option, if the two PDSCHs partially or fully overlap in time in non-overlapping PRBs, and if the total number of allocated PRBs of the two PDSCHs would exceed N_{BW} PRBs in a OFDM symbol, UE may only receive a subset of PRBs of the PDSCH scheduled with C-RNTI, MCS-C-RNTI, or CS-RNTI in the OFDM symbol so that the total number of the received PRBs of the two PDSCHs in any OFDM symbol does not exceed N_{BW} PRBs. With this option, in FIG. 3B, since the total number of RPBs for the two PDSCHs in OFDM symbol 5/6/7/8 is 30 which exceed N_{BW}, the RBW-RedCap UE may only receive 15 PRBs of the unicast PDSCH in OFDM symbol 5/6/7/8. By this way, the total number of received PRBs of the two PDSCHs does not exceed N_{BW} PRBs in any OFDM symbol.

In another option, if the two PDSCHs are in the same slot and if the total number of allocated PRBs of the two PDSCHs in a OFDM symbol would exceed N_{BW} PRBs, UE may only receive a subset of PRBs of the PDSCH scheduled with C-RNTI, MCS-C-RNTI, or CS-RNTI in the OFDM symbol so that the total number of the received PRBs of the two PDSCHs in any OFDM symbol does not exceed N_{BW} PRBs.

In one option, a RBW-RedCap UE does not expect to decode the two PDSCHs that partially or fully overlap in time in non-overlapping PRBs, if the total number of allocated PRBs of the two PDSCHs in any OFDM symbol exceeds N_{BW} PRBs.

In another option, a RBW-RedCap UE does not expect to decode the two PDSCHs in the same slot, if the total number of allocated PRBs of the two PDSCHs in any OFDM symbol exceeds N_{BW} PRBs.

In one embodiment, an RBW-RedCap UE does not expect that the allocated PRBs of a PDSCH span more than N_{BW} localized PRBs. The following options can be considered to handle a PDSCH scheduled with C-RNTI, MCS-C-RNTI, or CS-RNTI and, for P-RNTI triggered or autonomous SI acquisition, another PDSCH scheduled with SI-RNTI in the same slot.

In one option, a RBW-RedCap UE may be expected to decode the two PDSCHs that partially or fully overlap in time in non-overlapping PRBs, if the two PDSCHs are allocated within N_{BW} localized PRBs. Otherwise, the RBW-RedCap UE may only decode one of the two PDSCHs. The prioritized PDSCH may be determined by the RNTI. For example, the UE may not receive the PDSCH scheduled with C-RNTI, MCS-C-RNTI, or CS-RNTI.

In another option, a RBW-RedCap UE may be expected to decode the two PDSCHs in the same slot, if the two PDSCHs are allocated within N_{BW} localized PRBs. Otherwise, the RBW-RedCap UE may only decode one of the two PDSCHs. The prioritized PDSCH may be determined by the RNTI. For example, the UE may not receive the PDSCH scheduled with C-RNTI, MCS-C-RNTI, or CS-RNTI.

In another option, if the two PDSCHs partially or fully overlap in time in non-overlapping PRBs, and if the two PDSCHs span more than N_{BW} localized PRBs in a OFDM symbol, UE may only receive a subset of PRBs of the PDSCH scheduled with C-RNTI, MCS-C-RNTI, or CS-RNTI in the OFDM symbol so that the received PRBs of the two PDSCHs are within N_{BW} localized PRBs.

In another option, if the two PDSCHs are in the same slot and if the two PDSCHs span more than N_{BW} localized PRBs in a OFDM symbol, UE may only receive a subset of PRBs of the PDSCH scheduled with C-RNTI, MCS-C-RNTI, or CS-RNTI in the OFDM symbol so that the received PRBs of the two PDSCHs are within N_{BW} localized PRBs.

In one option, a RBW-RedCap UE does not expect to decode the two PDSCHs that partially or fully overlap in time in non-overlapping PRBs, if the two PDSCHs are not allocated within N_{BW} localized PRBs.

In another option, a RBW-RedCap UE does not expect to decode the two PDSCHs in the same slot, if the two PDSCHs are not allocated within N_{BW} localized PRBs.

In one embodiment, a RBW-RedCap UE does not expect that the total number of allocated REs of a PDSCH in a slot does not exceed a maximum number of N_{RE} or 12·N_{BW}·N_{sym} REs in a slot. The following options can be considered to handle a PDSCH scheduled with C-RNTI, MCS-C-RNTI, or CS-RNTI and, for P-RNTI triggered or autonomous SI acquisition, another PDSCH scheduled with SI-RNTI in the same slot.

In one option, a RBW-RedCap UE can decode the two PDSCHs that partially or fully overlap in time in non-overlapping PRBs, if the total number of allocated REs of the two PDSCHs in a slot does not exceed N_{RE} or 12·N_{BW}·N_{sym} REs. Otherwise, the RBW-RedCap UE may only decode one of the two PDSCHs. The prioritized PDSCH may be determined by the RNTI. For example, the UE may not receive the PDSCH scheduled with C-RNTI, MCS-C-RNTI, or CS-RNTI. With this option, the in FIG. 3A, since the total number of REs for broadcast PDSCH and unicast PDSCH is less than the limit e.g., 12·N_{BW}·N_{sym} where N_{BW} may be 25 and N_{sym} may equal to 14, the RBW-RedCap UE can decode the two PDSCHs.

In another option, a RBW-RedCap UE can decode the two PDSCHs in the same slot, if the total number of allocated REs of the two PDSCHs in a slot does not exceed N_{RE} or 12·N_{BW}·N_{sym} REs. Otherwise, the RBW-RedCap UE may only decode one of the two PDSCHs. The prioritized PDSCH may be determined by the RNTI. For example, the UE may not receive the PDSCH scheduled with C-RNTI, MCS-C-RNTI, or CS-RNTI.

In another option, if the two PDSCHs partially or fully overlap in time in non-overlapping PRBs, and if the total number of allocated REs of the two PDSCHs in a slot would exceed N_{RE} or 12·N_{BW}·N_{sym} REs, UE may only receive a subset of REs of the PDSCH scheduled with C-RNTI, MCS-C-RNTI, or CS-RNTI so that the total number of the received REs of the two PDSCHs in the slot does not exceed N_{RE} or 12·N_{BW}·N_{sym} REs

FIG. 4 illustrates one broadcast PDSCH and one unicast PDSCH, in accordance with some embodiments. FIG. 4 illustrates another example for one broadcast PDSCH plus one unicast PDSCH that are allocated and overlapped in one slot. It is assumed the broadcast PDSCH has 10 PRB and the unicast PDSCH has 20 PRBs. Note: localized PRB allocation are assumed for each PDSCH, though it may be allowed to schedule distributed PRBs for each PDSCH. The total number of allocated REs is 12·380 which exceeds 12·25·14=12·350. The RBW-RedCap UE may not receive the last 12·30 REs of the unicast PDSCH.

In another option, if the two PDSCHs are in the same slot and if the total number of allocated REs of the two PDSCHs in a slot would exceed N_{RE} or 12·N_{BW}·N_{sym} REs, UE may only receive a subset of REs of the PDSCH scheduled with C-RNTI, MCS-C-RNTI, or CS-RNTI in the slot so that the total number of the received REs of the two PDSCHs in the slot does not exceed N_{RE} or 12·N_{BW}·N_{sym} REs.

In one option, a RBW-RedCap UE does not expect to decode the two PDSCHs that partially or fully overlap in time in non-overlapping PRBs, if the total number of allocated REs of the two PDSCHs in a slot exceeds N_{RE} or 12·N_{BW}·N_{sym} REs.

In another option, a RBW-RedCap UE does not expect to decode the two PDSCHs in the same slot, if the total number of allocated REs of the two PDSCHs in a slot exceeds N_{RE} or 12·N_{BW}·N_{sym} REs.

In one embodiment, an RBW-RedCap UE does not expect that the sum of the TBS of a PDSCH scheduled with C-RNTI, MCS-C-RNTI, or CS-RNTI and the TBS of another PDSCH scheduled with SI-RNTI in the same slot for P-RNTI triggered or autonomous SI acquisition is larger than a threshold T. T can be predefined or reported as UE capability.

In one embodiment, an RBW-RedCap UE does not expect that the sum of the TBS of a PDSCH scheduled with C-RNTI, MCS-C-RNTI, or CS-RNTI and the TBS of another PDSCH scheduled with SI-RNTI in the same slot for P-RNTI triggered or autonomous SI acquisition exceeds a maximum data rate. The maximum data rate can be predefined or reported as UE capability. For example, as defined in TS 38.306,

$$data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \frac{{N}_{PRB}^{BW ( j ) , μ} \cdot 12}{{T}_{s}^{μ}} ( 1 - {OH}^{\text{?}} \text{?}$$

$$\text{?} \text{indicates text missing or illegible when filed}$$

The parameters in the formula may be set based on the characteristic of the RBW-RedCap UE.

In one embodiment, a RBW-RedCap UE does not expect to decode a PDSCH scheduled with C-RNTI, MCS-C-RNTI, or CS-RNTI and, for P-RNTI triggered or autonomous SI acquisition, another PDSCH scheduled with SI-RNTI that partially or fully overlap in time in non-overlapping PRBs.

In one embodiment, a RBW-RedCap UE does not expect to decode a PDSCH scheduled with C-RNTI, MCS-C-RNTI, or CS-RNTI and, for P-RNTI triggered or autonomous SI acquisition, another PDSCH scheduled with SI-RNTI in the same slot.

### Maximum Number of PDSCHs Under Processing

In one embodiment, an RBW-RedCap UE may expect to have received at most X PDCCHs for DCI formats 1_0, 1_1, or 1_2 with CRC scrambled by any RNTI scheduling X PDSCH receptions for which the UE has not received any corresponding PDSCH symbol and at most Y PDCCHs for DCI formats 0_0, 0_1, or 0_2 with CRC scrambled by any RNTI scheduling Y PUSCH transmissions for which the UE has not transmitted any corresponding PUSCH symbol. X, Y could be predefined, e.g., X=Y=16.

In one embodiment, a RBW-RedCap UE does not expect to be scheduled or configured to process more than X ongoing PDSCH receptions and more than Y ongoing PUSCH transmissions. X, Y could be predefined, e.g., X=Y=16 or reported as UE capability. The above PDSCH receptions include any dynamically scheduled or semi-statically configured PDSCH receptions including broadcast PDSCHs. The above PUSCH transmissions include any dynamically scheduled or semi-statically configured PUSCH transmissions.

A PDSCH or PUSCH may be considered as ‘ongoing’ from the first or last symbol of the PDCCH that schedules the PDSCH or PUSCH, or from the first allocated time symbol of the PDSCH or PUSCH, or from a time that is T_{proc,2} before the start of the PUSCH, T_{proc,2} is the PUSCH preparation time for the corresponding UE processing capability defined in TS 38.214. A PDSCH or PUSCH may be considered as ‘ongoing’ until an ACK is reported for the PDSCH or a toggled NDI is received in a DCI scheduling the HARQ process associated with the PDSCH, or until an ACK is received for the PUSCH or a toggled NDI is received in a DCI scheduling the HARQ process associated with the PUSCH.

### PDSCH and SSB, COREST or CSI-RS in Same Slot

In a slot, an RBW-RedCap UE may be configured or scheduled a PDSCH, and one or multiple of the following channels/signals: an SSB that can be configured by ssb-PositionslnBurst; a CORESET on which the RBW-RedCap UE needs to monitor PDCCH; and a CSI-RS resource that may be periodically configured or dynamically triggered.

The PDSCH and the one or multiple channels/signals may be partially or fully overlapped in time. Due to low processing capability, certain relaxations may be defined for reception of PDSCH and the one or multiple other DL channels/signals for the RBW-RedCap UE.

In one embodiment, for the PDSCH and the one or multiple channels/signals, a RBW-RedCap UE is not capable of receiving more than N_{BW} PRBs in any OFDM symbol in a slot. In order to count the total number of PRBs in a OFDM symbol, all the configured PRBs for the CORESET in the OFDM symbol are counted. Alternatively, only the monitored PRBs in the CORESET in the OFDM symbol are counted based on search space set configurations. A PRB in the CORESET is monitored if at least one PDCCH candidate of the UE is mapped to the PRB. For CSI-RS resource, a PRB in a OFDM symbol is counted if at least one RE of the CSI-RS is mapped to the PRB. The number of PRBs of a SSB if present is always counted. Alternatively, the number of PRBs of a SSB if present is only counted when the RBW-RedCap UE needs to detect the SSB.

A RBW-RedCap UE does not expect that the number of allocated PRBs of a PDSCH exceeds N_{BW} PRBs.

In one option, the UE may not expect that the total number of the PRBs of the PDSCH and the one or multiple channels/signals would exceed N_{BW} PRBs in any OFDM symbol in a slot.

In another option, if the total number of the PRBs of the PDSCH and the one or multiple channels/signals would exceed N_{BW} PRBs in a OFDM symbol, UE may not receive part or all of the CSI-RS resource or CSI-RS resource set. If the total number of the PRBs, after excluding part or all of CSI-RS resource or CSI-RS resource set, does not exceed N_{BW} PRBs in the OFDM symbol, UE may receive the PDSCH in the OFDM symbol.

In another option, if the total number of the PRBs of the PDSCH and the one or multiple channels/signals would exceed N_{BW} PRBs in a OFDM symbol, UE may not receive the PDSCH in the OFDM symbol or drop the PDSCH in the slot. The PDSCH may be punctured, or rate matched in the OFDM symbol if the number of received PRBs is to be reduced.

In another option, if the total number of the PRBs of the PDSCH and the one or multiple channels/signals would exceed N_{BW} PRBs in a OFDM symbol, UE may receive a subset of PRBs of the PDSCH in the OFDM symbol if the total number of the received PRBs of the PDSCH and the one or multiple channels/signals in any OFDM symbol does not exceed N_{BW} PRBs. The PDSCH may be punctured, or rate matched in the OFDM symbol if the number of received PRBs is to be reduced.

A RBW-RedCap UE does not expect that the allocated PRBs of a PDSCH span more than N_{BW} localized PRBs.

In one option, the UE may not expect that the allocated PRBs of the PDSCH and the one or multiple channels/signals span more than N_{BW} localized PRBs in any OFDM symbol in a slot.

In another option, if the allocated PRBs of the PDSCH and the one or multiple channels/signals span more than N_{BW} localized PRBs in any OFDM symbol, UE may not receive part or all of the CSI-RS resource or CSI-RS resource set. If the allocated PRBs, after excluding part or all of CSI-RS resource or CSI-RS resource set, are allocated within N_{BW} localized PRBs in the OFDM symbol, UE may receive the PDSCH in the OFDM symbol.

In another option, if the allocated PRBs of the PDSCH and the one or multiple channels/signals span more than N_{BW} localized PRBs in a OFDM symbol, UE may not receive the PDSCH in the OFDM symbol or drop the PDSCH in the slot. The PDSCH may be punctured, or rate matched in the OFDM symbol if the number of received PRBs is to be reduced.

In another option, if the allocated PRBs of the PDSCH and the one or multiple channels/signals span more than N_{BW} localized PRBs in a OFDM symbol, UE may receive a subset of PRBs of the PDSCH in the OFDM symbol if remaining PRBs of the PDSCH and the one or multiple channels/signals in any OFDM symbol are allocated within N_{BW} localized PRBs. The PDSCH may be punctured, or rate matched in the OFDM symbol if the number of received PRBs is to be reduced.

In one embodiment, for the PDSCH and the one or multiple channels/signals, a RBW-RedCap UE is not capable of receiving more than a maximum number of N_{RE} or 12·N_{BW}·N_{sym} REs in a slot. In order to count the total number of REs in a slot, all the configured REs for the CORESET in the OFDM symbol are counted. Alternatively, only the monitored REs in the CORESET in the OFDM symbol are counted. A RE in the CORESET is monitored if at least one PDCCH candidate of the UE is mapped to the RE. For CSI-RS resource, the allocated REs of the CSI-RS resource is counted. The number of REs of a SSB if present is always counted. Alternatively, the number of REs of a SSB if present is only counted when the RBW-RedCap UE needs to detect the SSB. A RBW-RedCap UE does not expect that the number of allocated REs of a PDSCH exceeds N_{RE} or 12·N_{BW}·N_{sym} REs.

In one option, the UE may not expect that the total number of the REs of the PDSCH and the one or multiple channels/signals would exceed NVR or 12·N_{BW}·N_{sym} REs in a slot.

In another option, if the total number of the REs of the PDSCH and the one or multiple channels/signals would exceed N_{RE} or 12·N_{BW}·N_{sym}, REs in a slot, UE may not receive part or all of the CSI-RS resource or CSI-RS resource set. If the total number of the REs, after excluding part or all of CSI-RS resource or CSI-RS resource set, does not exceed N_{RE} or 12·N_{BW}·N_{sym} REs in the slot, UE may receive the PDSCH in the slot.

In another option, if the total number of the REs of the PDSCH and the one or multiple channels/signals would exceed N_{RE} or 12·N_{BW}·N_{sym}, REs in a slot, UE may not receive the PDSCH.

In another option, if the total number of the REs of the PDSCH and the one or multiple channels/signals would exceed N_{RE} or 12·N_{BW}·N_{sym} REs in a slot, UE may only receive a subset of REs of the PDSCH if the total number of the received REs of the PDSCH and the one or multiple channels/signals in the slot does not exceed N_{RE} or 12·N_{BW}·N_{sym} REs. The PDSCH may be punctured, or rate matched if the number of received REs is to be reduced.

In one example, except for a PDSCH scheduled with SI-RNTI and the system information indicator in DCI is set to 0, the UE assumes SS/PBCH block transmission according to ssb-PositionslnBurst, for a RBW-RedCap UE, due to low processing capability, certain relaxation applies to reception of SS/PBCH block and a PDSCH that partially or fully overlap in time.

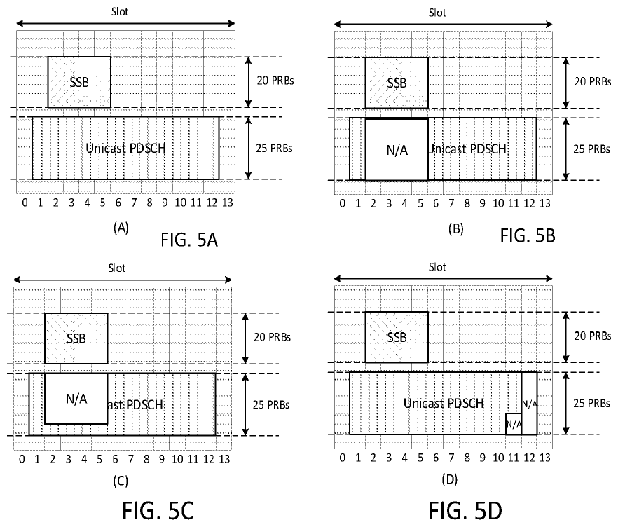

FIGS. 5A, 5B, 5C and 5D illustrate reception of an SSB and one unicast PDSCH, in accordance with some embodiments. FIGS. 5A, 5B, 5C and 5D illustrate four cases for reception of SSB and one unicast PDSCH that are allocated and overlapped in one slot. It is assumed the unicast PDSCH has 25 PRBs. Note: localized PRB allocation are assumed for the PDSCH, though it may be allowed to schedule distributed PRBs for the PDSCH.

In FIG. 5A, since the total number of RPBs for the SSB and the PDSCH in OFDM symbol 2/3/4/5 exceeds N_{BW}, the unicast PDSCH is not valid scheduling/configuration for the RBW-RedCap UE. In FIG. 5B, since the total number of RPBs for the SSB and the PDSCH in OFDM symbol 2/3/4/5 exceeds N_{BW}, all allocated PRBs of the unicast PDSCH in OFDM symbol 2/3/4/5 are not received for the RBW-RedCap UE. In FIG. 5C, since the total number of RPBs for the SSB and the PDSCH in OFDM symbol 2/3/4/5 exceeds N_{BW}, only 5 allocated PRBs of the unicast PDSCH in OFDM symbol 2/3/4/5 can be received for the RBW-RedCap UE, so that the total number of the received PRBs of the PDSCH and the PRBs of the SS/PBCH block in any OFDM symbol does not exceed 25 PRBs. In FIG. 5D, the total number of REs for the SSB and the PDSCH 12·380, which exceeds 12·25·14=12·350. The RBW-RedCap UE may not receive the last 12·30 REs of the unicast PDSCH.

In another example, for a RBW-RedCap UE, due to low processing capability, certain relaxation applies to reception of PDCCH and a PDSCH that partially or fully overlap in time. A NR UE may need to detect PDCCH in a CORSET and receive a PDSCH in the overlapped OFDM symbols. If a PDSCH scheduled by a PDCCH would overlap with resources in the CORESET containing the PDCCH, the resources corresponding to a union of the detected PDCCH that scheduled the PDSCH and associated PDCCH DM-RS are not available for the PDSCH. When precoderGranularity configured in a CORESET where the PDCCH was detected is set to ‘allContiguousRBs’, the associated PDCCH DM-RS are DM-RS in all REGs of the CORESET. Otherwise, the associated DM-RS are the DM-RS in REGs of the PDCCH.

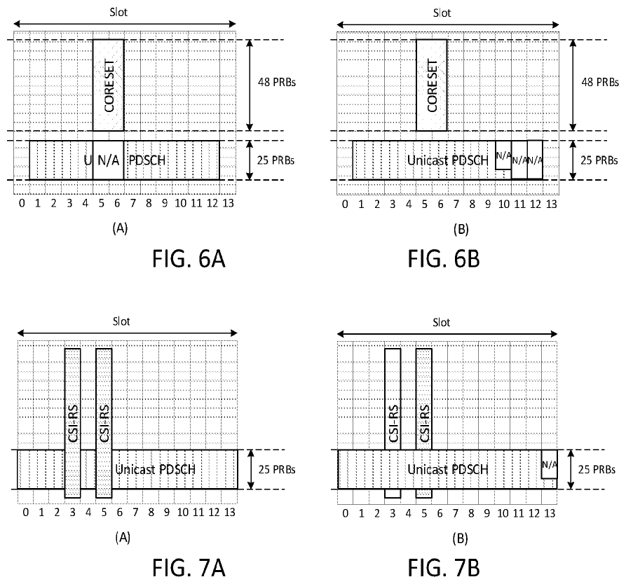

FIGS. 6A and 6B illustrate reception of a CORESET and a unicast PDSCH, in accordance with some embodiments. FIGS. 6A and 6B illustrate two cases for reception of CORESET and one PDSCH that are allocated and overlapped in one slot. It is assumed the unicast PDSCH has 25 PRBs. Note: localized PRB allocation are assumed for the PDSCH, though it may be allowed to schedule distributed PRBs for the PDSCH.

In FIGS. 6A and 6B, since the total number of RPBs for the CORESET and the PDSCH in OFDM symbol 5 & 6 exceeds N_{BW}, the PDSCH is not valid scheduling/configuration for the RBW-RedCap UE. In FIG. 6A, since the total number of RPBs for the CORESET and the PDSCH in OFDM symbol 5/6 exceeds N_{BW}, all allocated PRBs of the PDSCH in OFDM symbol 5/6 are not received for the RBW-RedCap UE. In FIG. 6B, since the total number of REs for the CORESET and the PDSCH exceeds 12·25·14=12·350, the RBW-RedCap UE may not receive a number of last REs of the PDSCH.

In another example, for a RBW-RedCap UE, due to low processing capability, certain relaxation applies to reception of PDSCH and a CSI-RS resource that partially or fully overlap in time.

FIGS. 7A and 7B illustrate reception of a CSI-RS and a unicast PDSCH, in accordance with some embodiments. FIGS. 7A and 7B illustrate two cases for reception of CSI-RS resource and one PDSCH that are allocated and overlapped in a slot. It is assumed the unicast PDSCH has 25 PRBs. Note: localized PRB allocation are assumed for the PDSCH, though it may be allowed to schedule distributed PRBs for the PDSCH.

In FIGS. 7A and 7B, since the total number of RPBs for the CSI-RS resource and the PDSCH in OFDM symbol 3 & 5 exceeds N_{BW}, the CSI-RS resource and the PDSCH is not valid scheduling/configuration for the RBW-RedCap UE. In FIG. 7A, since the total number of RPBs for the CSI-RS resource and the PDSCH in OFDM symbol 3 & 5 exceeds N_{BW}, all allocated PRBs of the PDSCH in OFDM symbol 3 & 5 are not received for the RBW-RedCap UE. UE can still receive the CSI-RS resource in OFDM symbol 3 & 5. In FIG. 7B, since the total number of REs for the CSI-RS resource and the PDSCH exceeds 12·25·14=12·350, the RBW-RedCap UE may not receive a number of last REs of the PDSCH.

In one embodiment, except for a PDSCH scheduled with SI-RNTI and the system information indicator in DCI is set to 0, a RBW-RedCap UE assumes SS/PBCH block transmission according to ssb-PositionslnBurst, and if the PDSCH resource allocation overlaps with PRBs containing SS/PBCH block transmission resources the RBW-RedCap UE shall assume that the PRBs containing SS/PBCH block transmission resources are not available for PDSCH in the OFDM symbols where SS/PBCH block is transmitted. Otherwise, RBW-RedCap UE may receive the PDSCH in the allocated PRBs for the PDSCH. The RBW-RedCap UE does not expect that the number of allocated PRBs of a PDSCH exceeds N_{BW} PRBs, or N_{RE} or 12·N_{BW}·N_{sym} REs.

In one embodiment, if a PDSCH scheduled by a PDCCH would overlap with resources in the CORESET containing the PDCCH, the resources corresponding to a union of the detected PDCCH that scheduled the PDSCH and associated PDCCH DM-RS are not available for the PDSCH. Otherwise, RBW-RedCap UE may receive the PDSCH in the allocated PRBs for the PDSCH. The RBW-RedCap UE does not expect that the number of allocated PRBs of a PDSCH exceeds N_{BW} PRBs, or N_{RE} or 12·N_{BW}·N_{sym} REs.

In one embodiment, if a PDSCH and a CSI-RS resource are configured in a same OFDM symbol, UE can receive both the PDSCH and the CSI-RS resource. The RBW-RedCap UE does not expect that the number of allocated PRBs of a PDSCH exceeds N_{BW} PRBs, or N_{RE} or 12·N_{BW}·N_{sym} REs.

In one embodiment, if a CORESET and a CSI-RS resource are configured in a same OFDM symbol, there is no limitation on the total number of occupied PRBs of the CORESET and the CSI-RS resource.

In one embodiment, if a CORESET and a SSB are configured in a same OFDM symbol, there is no limitation on the total number of occupied PRBs of the CORESET and the SSB.

In one embodiment, if a CSI-RS resource and a SSB are configured in a same OFDM symbol, there is no limitation on the total number of occupied PRBs of the CSI-RS resource and the SSB.

x In order to reduce the cost, further reduction of bandwidth at least for data channel of the base band (BB) processing can be considered for the RBW-RedCap UE. Consequently, the complexity of the post-FFT data buffer, receiver processing block, LDPC decoding and HARQ buffer can be reduced. Throughout this description, 5 MHz BW for BB processing allows two possible implementations unless specially described: 1) The 5 MHz BW can be localized N_{BW} PRBs; or, 2) The 5 MHz BW can be distributed N_{BW} PRBs if the 20 MHz BW of RF is supported. For example, N_{BW} equals to 25.

In FIGS. 1D and 1E, the localized N_{BW} PRBs for the UE operation should be known first. Then, the PDCCH monitoring and the PDSCH or PUSCH transmission are restricted in the N_{BW} PRBs. On the other hand, in FIG. 1C, potentially allows different operations. Since UE is capable of PDCCH monitoring in 20 MHz BW, there may be no limitation on PDCCH monitoring at all. Alternatively, though a CORESET of up to 20 MHz can be supported by the UE, the number of detected PRBs for PDCCH monitoring in the CORESET may be still limited to no more than N_{BW} PRBs.

Regarding PDSCH or PUSCH transmission, the number of allocated PRBs of PDSCH or PUSCH transmission is limited to no more than N_{BW} PRBs. The allocated PRBs may be within localized N_{BW} PRBs. Alternatively, the allocated PRBs may be distributed N_{BW} PRBs.

FDRA within Localized 5 MHz BW

If the size of a configured DL/UL BWP is larger than N_{BW} PRBs, due to the reduced BW capability for at least PDSCH for an RBW-RedCap UE, a frequency region of up to N_{BW} consecutive PRBs may be identified first. Note: the different frequency regions may have same or different number of PRBs. Then, the allocated frequency resource for DL/UL transmission can be indicated within the identified frequency region. In one example, the UE may expect that the start or end of a frequency region can be aligned with the boundary of the Resource Block Group (RBG) of FDRA type 0 for the DL/UL BWP.

In one embodiment, the DL/UL BWP may be divided into K localized frequency region. In one option, the K frequency regions are not overlapped, K=[N_{BWP}^{size}/Y] or [N_{BWP}^{size}/Y], where the size of the BWP is N_{BWP}^{size}, the size of the frequency region is Y. Specifically, the frequency region k,k=0, 1, . . . , K−1, includes the PRBs with indexes k·Y+i, i=0, 1, 2, . . . In another option, the K frequency regions can be overlapped. Therefore, a larger number of frequency regions are supported in the DL/UL BWP which results more bits to identify a frequency region for frequency resource allocation.

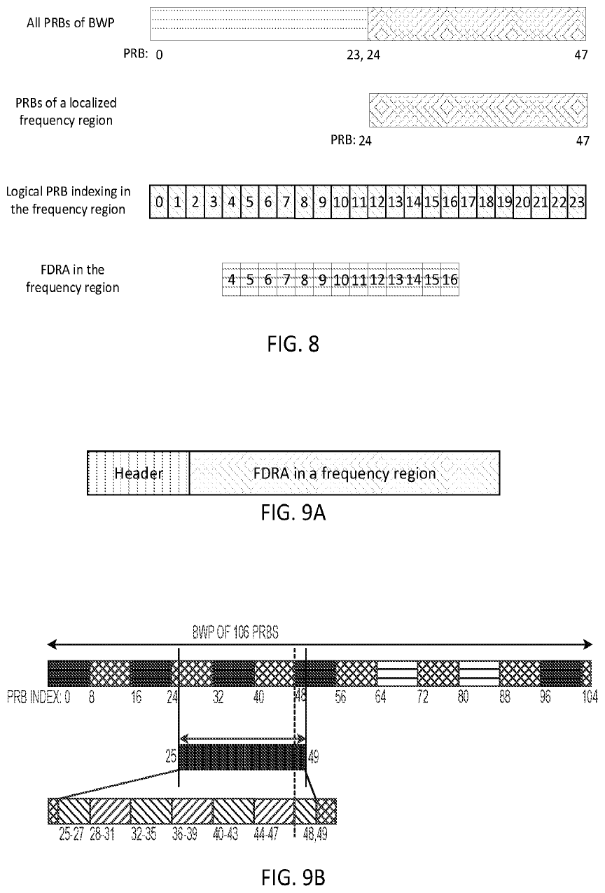

FIG. 8 illustrates a frequency region with localized PRBs and FDRA, in accordance with some embodiments. FIG. 8 illustrates one example of the localized frequency region and FDRA. In FIG. 8, a BWP of 48 PRBs is divided into 2 localized frequency regions of 24 PRBs. The 24 PRBs in the frequency region is logically indexed by 0 to 23. Finally, the existing FDRA can be used to allocate logical PRBs, e.g., from 4 to 16 as if it is a BWP of 24 consecutive PRBs.

In one embodiment, the frequency region of up to N_{BW} consecutive PRBs for DL/UL transmission of an RBW-RedCap UE can be predefined or determined by a fixed rule with respect to the CORESET #0 which is indicated by the cell-defining SSB (CD-SSB). Alternatively, the frequency region may be semi-statically configured by high layer signaling, e.g., BWP configuration. Alternatively, the frequency region may be activated by MAC CE. Alternatively, the DCI format can dynamically indicate the active frequency region, which could be separated from or jointly coded with the BWP indicator. Consequently, to indicate an allocated frequency resource for DL/UL transmission, the existing FDRA scheme(s) defined in TS 38.214 can be applied within the frequency region.

In one embodiment, the frequency resource for DL/UL transmission may be dynamically allocated within the DL/UL BWP of up to 20 MHz, subjected to a limitation that the allocated PRBs must be within localized N_{BW} PRBs.

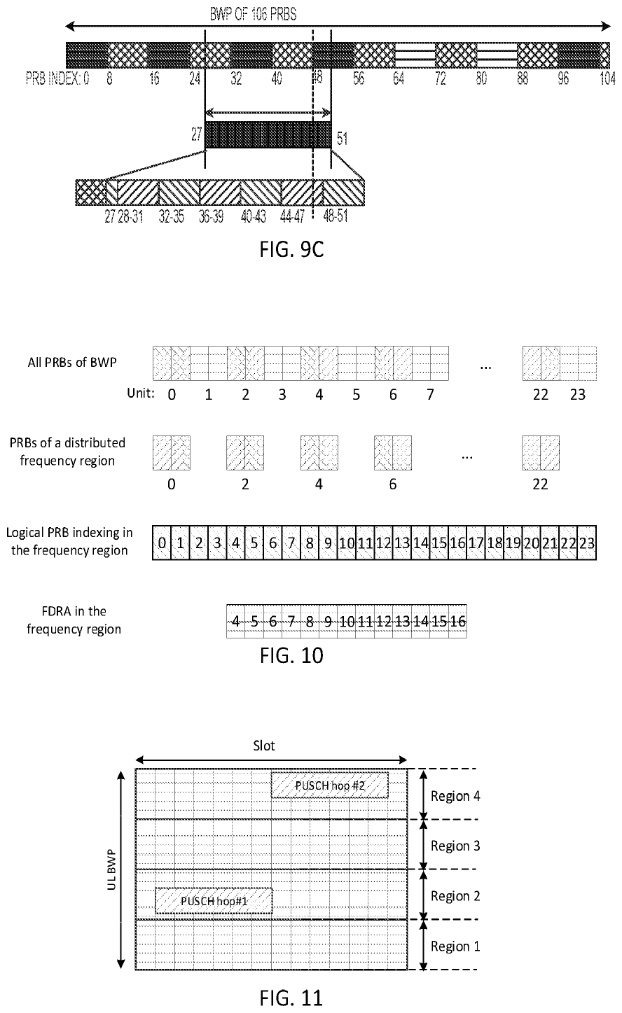

In one option, a frequency region of up to N_{BW} consecutive PRBs for DL/UL transmission of an RBW-RedCap UE is dynamically indicated by a header part of the FDRA field in a DCI format. Then, an allocated frequency resource for DL/UL transmission within the frequency region indicated by the header can be indicated by remaining part of the DFRA field, e.g., using the existing FDRA scheme(s) defined in TS 38.214. FIG. 9A illustrates FDRA with a heady for frequency region in indication, in accordance with some embodiments. FIG. 9A illustrates one example of the construction of the FDRA field. For example, for a BWP of 20 MHz, it may be divided into 4 frequency regions of 5 MHz. Therefore, the size of the header can be 2 bits.

For a frequency region of Y consecutive PRBs, Y<=N_{BW}, different type of FDRA scheme(s) can be applied to the frequency set: For FDRA type 0, the resource block assignment information includes a bitmap indicating the Resource Block Groups (RBGs) that are allocated to the UE where a RBG is a set of consecutive PRBs. The Size of RBG from TS 38.214 is cited in Table 1. The applicable RBG size in the frequency region of Y consecutive PRBs may be determined by the Table 1 assuming a BWP size of Y PRBs. Based on Table 1, the applicable RBG size can be 2 or 4 for configuration 1 or 2. For example, for a frequency region of Y=25 PRBs, with RBG configuration 1, i.e., 2 PRBs per RBG, the bitmap size is 13 bits. Therefore, total number of bits for FDRA is 2+13=15 bits assuming 4 frequency regions can be dynamically indicated. The application of Configuration 1 or configuration 2 for the frequency region of Y consecutive PRBs may reuse the same configuration as the BWP. Alternatively, the application of Configuration 1 or configuration 2 for the frequency region of Y consecutive PRBs may be separately configured from the BWP. The RBG size in the frequency region of Y consecutive PRBs may be configured by high layer signaling.

TABLE 1
Nominal RBG size P

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

For FDRA type 1, the resource block assignment information indicates to a UE a set of contiguously allocated non-interleaved or interleaved virtual resource blocks. In the frequency region of Y consecutive PRBs, the required number of bits is [log₂(Y·(Y+1)/2)]. With a frequency region of Y=25, the required number of bits is 9. Therefore, total number of bits for FDRA is 2+9=11 bits assuming 4 frequency regions can be dynamically indicated.

In one example, assuming the PRBs in a frequency region of Y consecutive PRBs is index from 0 to Y−1, the k_th RBG may contain P PRB indexes starting from k·P, k=0, 1, . . . , [Y/P]−1. The last RBG only consists of mnod(Y, P) PRBs.

In another example, the boundary of the RBG in the frequency region of Y consecutive PRBs can be aligned with the boundary of the RBG of the DL/UL BWP. FIG. 9B illustrates two partial RBG in the frequency region of PRBs, in accordance with some embodiments. FIG. 9B illustrates one example of RBG allocation in a frequency region of PRB indexes 25 to 49 in a BWP of 106PRBs. It is assumed RBG size of the BWP is 8 while RBG size of the frequency region is 4. To align with RBG boundary of the BWP, the first RBG of the frequency region consists of PRB indexes 25 to 27. On the other hand, the last RBG of the frequency region consists of PRB indexes 48, 49. FIG. 9C illustrates a single partial RBG in the frequency region of 25 PRBs, in accordance with some embodiments. FIG. 9C illustrates another example of RBG allocation in a frequency region of PRB indexes 27 to 51 in a BWP of 106PRBs. It is assumed RBG size of the BWP is 8 while RBG size of the frequency region is 4. To align with RBG boundary of the BWP, the first RBG of the frequency region only consists of PRB index 27. All other RBGs have equal size of 4 PRBs.

In an example, a UE may be provided by higher layers with an offset, in terms of a number of PRBs, with respect to the lowest PRB index within the frequency region of Y consecutive PRBs to indicate the start of the second RBG used for resource allocation within the region of Y consecutive PRBs and the first RBG within the frequency region may correspond to the PRBs corresponding to the indicated offset. The value of the offset may range from 0 to RBGsize−1, where RBGsize is the size of the RBG for scheduling within the frequency region of Y consecutive PRBs. In a further example, the values of the offsets for DL and UL may be provided separately to a UE.

Alternatively, in this option, the header for frequency region indication may be treated as a separate field in the DCI format, in addition to the DCI field indicating an allocated frequency resource for DL/UL transmission within the frequency region indicated by the separate DCI field.

In another option, to indicate an allocated frequency resource for DL/UL transmission in localized N_{BW} PRBs, the existing FDRA scheme(s) defined in TS 38.214 within the BWP can be applied. In one example, for Type 1 FDRA, for a BWP of 106 PRBs, the required number of bits is 13. In another example, for Type 0 FDRA, with RBG configuration 1, i.e., 8 PRBs per RBG, the bitmap size may be 14 bits. In this option, if the total number of allocated PRBs is more than N_{BW} for a UE, the UE may only receive or transmit in the N_{BW} lowest allocated PRBs.

FDRA within Distributed 5 MHz BW

If the size of a configured DL/UL BWP is larger than N_{BW} PRBs, due to the reduced BW capability for at least PDSCH for an RBW-RedCap UE, a frequency region of up to N_{BW} distributed PRBs may be identified first. Note: the frequency region can include non-consecutive PRBs. Note: the different frequency regions may have same or different number of PRBs. The PRBs in the frequency region are indexed from 0 to Y−1, Y is the total number of PRBs in the frequency region. Therefore, the frequency region can be treated as Y consecutive logical PRBs. Finally, the allocated frequency resource for DL/UL transmission can be indicated within the logical PRBs of identified frequency region.

In one embodiment, the DL/UL BWP may be divided into K combs and each comb is a frequency region, K=[N_{BWP}^{size}/Y] or [N_{BWP}^{size}/Y], where the size of the BWP is N_{BWP}^{size}. Specifically, the frequency region k,k=0, 1, . . . , K−1, includes the PRBs with indexes K·i+k, i=0, 1, 2, . . .

In one embodiment, with a unit of X consecutive PRBs, a frequency region can be a number equally spaced units in the DL/UL BWP. For a DL/UL BWP with N_{BWP}^{size} PRBs, it can be divided into [N_{BWP}^{size}/X] units which are indexed from 0 to [N_{BWP}^{size}/X]−1. Therefore, the frequency region k,k=0, 1, . . . , K−1, includes the units with indexes K·i+k, i=0, 1, 2, . . . The size X of a unit can be the size of a RBG as defined by Table 1 based on size NCP N_{BWP}^{size} of the DL/UL BWP. Alternatively, the size X of a unit can be the size of a RBG as defined by Table 1 assuming a BWP size of Y PRBs. Alternatively, the size X of a unit can be the size of a Precoding Resource Block Group (PRG) as defined in TS 38.214.

FIG. 10 illustrates a frequency region with distributed PRBs and FDRA, in accordance with some embodiments. FIG. 10 illustrates one example of the distributed frequency region and FDRA. In FIG. 10, a BWP of 48 PRBs is divided into 2 distributed frequency regions of 24 PRBs. The BWP consist of 12 units each with 2 PRBs. A first frequency region includes the units 2k, k=0, 1, 0.11 which have 24 PRBs totally. The 24 PRBs in the frequency region is logically indexed by 0 to 23. Finally, the existing FDRA can be used to allocate logical PRBs, e.g., from 4 to 16 as if it is a BWP of 24 consecutive PRBs. Note: the actual allocated PRBs are distributed in the DL/UL BWP.

In one embodiment, the frequency region of up to N_{BW} distributed PRBs for DL/UL transmission of a RBW-RedCap UE can be predefined or determined by a fixed rule with respect to the CORESET #0 which is indicated by the cell-defining SSB (CD-SSB). Alternatively, the frequency region may be semi-statically configured by high layer signaling, e.g., BWP configuration. Alternatively, the frequency region may be activated by MAC CE. Alternatively, the DCI format can dynamically indicate the active frequency region, which could be separated from or jointly coded with the BWP indicator. Consequently, to indicate an allocated frequency resource for DL/UL transmission, the existing FDRA scheme(s) defined in TS 38.214 can be applied within logical PRBs of the frequency region.

In one embodiment, the frequency resource for DL/UL transmission may be dynamically allocated within the DL/UL BWP of up to 20 MHz, subjected to a limitation that the allocated PRBs must be within N_{BW} PRBs.

In one option, a frequency region of up to N_{BW} distributed PRBs for DL/UL transmission of a RBW-RedCap UE is dynamically indicated by a header part of the FDRA field in a DCI format. Then, an allocated frequency resource for DL/UL transmission within the logical PRBs of the frequency region indicated by the header can be indicated by remaining part of the DFRA field, e.g., using the existing FDRA scheme(s) defined in TS 38.214, as shown in FIG. 9A. For example, for a BWP of 20 MHz, it may be divided into 4 frequency regions of 5 MHz. Therefore, the size of the header can be 2 bits.

For a frequency region of Y distributed PRBs, Y<=N_{BW}, different type of FDRA scheme(s) can be applied to the frequency set.

For FDRA type 0, the resource block assignment information includes a bitmap indicating the Resource Block Groups (RBGs) that are allocated to the UE where a RBG is a set of consecutive PRBs. The Size of RBG from TS 38.214 is cited in Table 1. The applicable RBG size in the frequency region of Y consecutive PRBs may be determined by the Table 1 assuming a BWP size of Y PRBs. Based on Table 1, the applicable RBG size can be 2 or 4 for configuration 1 or 2. For example, for a frequency region of Y=25 PRBs, with RBG configuration 1, i.e., 2 PRBs per RBG, the bitmap size is 13 bits. Therefore, total number of bits for FDRA is 2+13=15 bits assuming 4 frequency regions can be dynamically indicated. With smaller RBG size, the more flexible frequency resource allocation can be supported. The application of Configuration 1 or configuration 2 for the frequency region of Y consecutive PRBs may reuse the same configuration as the BWP. Alternatively, the application of Configuration 1 or configuration 2 for the frequency region of Y consecutive PRBs may be separately configured from the BWP. The RBG size in the frequency region of Y consecutive PRBs may be configured by high layer signaling.

For FDRA type 1, the resource block assignment information indicates to a UE a set of contiguously allocated non-interleaved or interleaved virtual resource blocks. In the frequency region of Y consecutive PRBs, the required number of bits is [log₂(Y·(Y+1)/2)]. With a frequency region of Y=25, the required number of bits is 9. Therefore, total number of bits for FDRA is 2+9=11 bits assuming 4 frequency regions can be dynamically indicated. With this option, the number of FDRA bits can be reduced for DCI overhead reduction.

Alternatively, in this option, the header for frequency region indication may be treated as a separate field in the DCI format, in addition to the DCI field indicating an allocated frequency resource for DL/UL transmission within the frequency region indicated by the separate DCI field.

In another option, to indicate an allocated frequency resource for DL/UL transmission in distributed N_{BW} PRBs, the existing FDRA defined in TS 38.214 within the BWP can be applied. In one example, for Type 0 FDRA, with RBG configuration 1, i.e., 8 PRBs per RBG, the bitmap size may be 14 bits. In another example, for Type 1 FDRA, for a BWP of 106 PRBs, the required number of bits is 13. In this option, if the total number of allocated PRBs is more than N_{BW} for a UE, the UE may only receive or transmit in the N_{BW} lowest allocated PRBs.

In another embodiment, one or multiple frequency regions can be configured and one of the configured frequency regions can be dynamically indicated by the header part of the FDRA field in a DCI format. Each frequency region is defined within the DL/UL BWP of up to 20 MHz, subjected to a limitation of up to N_{BW} PRBs. A frequency region may consist of up to N_{BW} consecutive PRBs, or up to N_{BW} PRBs that can be distributed in the DL/UL BWP. Further, the frequency resource for DL/UL transmission within the frequency region indicated by the header can be indicated by the remaining part of the FDRA field, e.g., using the existing FDRA scheme(s) defined in TS 38.214, as shown in FIG. 9A.

Hopping within 20 Mhz BWP

For Option B shown in FIG. 1E, though the BB of a UE is limited to 5 MHz, the UE has capability of 20 MHz for the RF. It would be possible to configure a DL/UL BWP of up to 20 MHz for the UE. Further, fast switching between different 5 MHz subbands within the BWP may be possible for the UE since there is no change of RF operation. Regarding Option C shown in FIG. 1F, since the control signaling can be transmitted in a BW of up to 20 MHz, it is straightforward that the DL/UL BWP can be up to 20 MHz for the UE. Assuming a PDSCH/PUSCH transmission is limited within localized N_{BW} PRBs, fast switching between different 5 MHz subbands within the BWP may be applicable.

For a configured DL/UL BWP with more than N_{BW} PRBs, the DL/UL BWP may be divided into K localized frequency regions, K>1. Assuming the frequency resource of a PDSCH or PUSCH transmission is limited within localized N_{B}w PRBs in an OFDM symbol, the frequency hopping across different frequency regions can be supported for frequency diversity gain.

In one option, the UE expects that each hop of the PDSCH or PUSCH transmission is located within a frequency region. The starting PRB for a hop is determined in accordance with the DL/UL BWP. In particular, the starting PRB in each hop for the PUSCH transmission is given by:

$${RB}_{start} = \{ \begin{matrix}{RB}_{start} & i = 0 \\ ( {RB}_{start} + {RB}_{offset} ) mod {N}_{BWP}^{size} & i = 1\end{matrix}$$

Where i=O and i=1 are the first hop and the second hop respectively in the same slot for intra-slot hopping or in two consecutive slots for inter-slot hopping, and RBₛₜₐᵣₜ is the starting RB within the DL/UL BWP, as calculated from the resource block assignment information of resource allocation type 1 or as calculated from the resource assignment for MsgA PUSCH and RB_{offset} the frequency offset in RBs between the two frequency hops. The UE does not expect that a second or later hop of the PDSCH or PUSCH transmission will span two frequency regions. FIG. 11 illustrates frequency hopping between different frequency regions, in accordance with some embodiments.

In another option, the UE expects that each hop of the PDSCH or PUSCH transmission is located within a frequency region and the same FDRA as the first hop applies in each frequency region. Assuming the first hop is allocated in the frequency region r with a start PRB in the frequency region [symbol] RB [symbol] _start\hat{ }FDRA, which corresponds to a start PRB “R” “B” _“start” within the DL/UL BWP, the frequency region “r” _“next” of the next hop is the frequency region which include the PRB with index (RB_start+RB_offset) mod [symbol] [symbol] N_BWP\hat{ }size [symbol] or ( [symbol] RB [symbol] _start\hat{ }region+“R” “B” _“offset”) mod [symbol] [symbol] N_BWP\hat{ }size [symbol] , where [symbol] RB [symbol] _start\hat{ }region is the start PRB of frequency region r. The start PRB of the next hop in the frequency region “r” _“next” is still [symbol] RB [symbol] _start\hat{ }FDRA, Alternatively, the parameter “R” “B” _“offset” may be reinterpreted as the offset in unit of frequency region. Assuming the first hop is allocated in the frequency region r with a start PRB in the frequency region [symbol] RB [symbol] _start\hat{ }region, a next hop by applying “R” “B” _“offset” is in the frequency region “r” _“next”=(r+“R” “B” _“offset”)mod K with a start PRB in the frequency region [symbol] RB [symbol] _start\hat{ }region, where K is the total number of frequency regions.

[symbol]

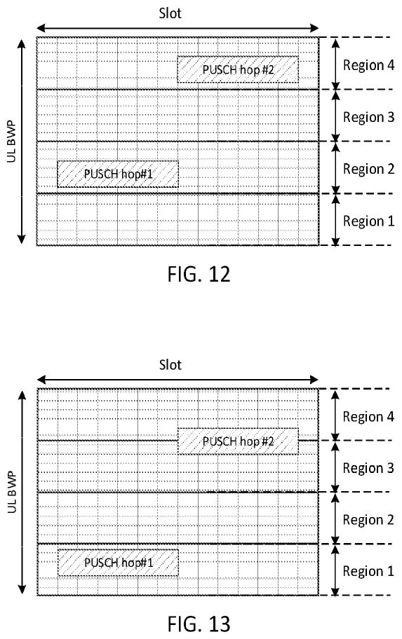

FIG. 12 illustrates frequency hopping with a same FDRA in each frequency region, in accordance with some embodiments. FIG. 12 illustrates one example on the frequency hopping of PUSCH transmission with same FDRA within the different frequency regions.

In another option, the UE expects that each hop of the PDSCH or PUSCH transmission is located within a frequency region and the mirror of the FDRA is applied within the frequency region of every second hop. In FDRA indicated by a DCI format applies to the first hop. Further, denote the frequency region of the next hop rₙₑₓₜ, the mirror of FDRA in the frequency region rₙₑₓₜ is used if rₙₑₓₜ mod 2=1, otherwise, the FDRA directly applies.

In another option, the UE expects that the first hop of the PDSCH or PUSCH transmission must be located within a frequency region. For example, for a scheduled PDSCH or PUSCH transmission, the frequency resource is allocated within a frequency region. Then, as to other hops, it is allowed that the hop may cross the boundary of two frequency regions. FIG. 13 illustrates frequency hopping across frequency regions with a second hop spanning two adjacent frequency regions, in accordance with some embodiments.

In one option, for a PDSCH or PUSCH transmission with repetitions, multiple values of RB_{offset} may be supported. For example, if RB_{offset} has 3 values, 4 different hopping frequencies can be supported for the PDSCH or PUSCH transmission with repetitions. By this way, for a BWP of 20 MHz which is divided into 4 frequency regions, it is possible that the 4 hops of the same PDSCH or PUSCH transmission can be transmitted in the 4 frequency regions respectively which maximize the frequency diversity gain. In particular, the starting PRB in each hop with number i for the PUSCH transmission is given by:

$${RB}_{start} = \{ \begin{matrix}{RB}_{start} & i = 0 \\ ( {RB}_{start} + {RB}_{offset , i} ) mod {N}_{BWP}^{size} & i = 1 , 2 , 3\end{matrix}$$

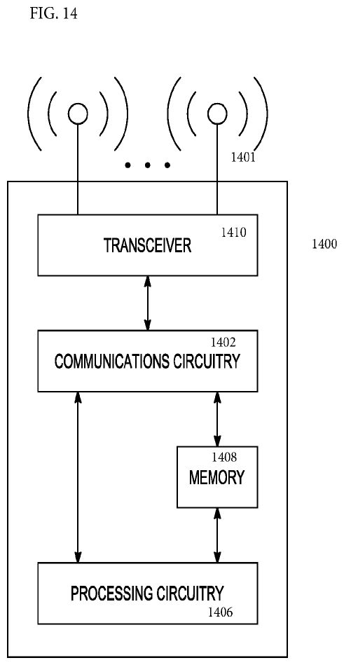

FIG. 14 illustrates a functional block diagram of a wireless communication device, in accordance with some embodiments. Wireless communication device 1400 may be suitable for use as a UE or gNB configured for operation in a 5G NR network. In some embodiments, device 1400 may be a RedCap UE. The communication device 1400 may include communications circuitry 1402 and a transceiver 1410 for transmitting and receiving signals to and from other communication devices using one or more antennas 1401. The communications circuitry 1402 may include circuitry that can operate the physical layer (PHY) communications and/or medium access control (MAC) communications for controlling access to the wireless medium, and/or any other communications layers for transmitting and receiving signals. The communication device 1400 may also include processing circuitry 1406 and memory 1408 arranged to perform the operations described herein. In some embodiments, the communications circuitry 1402 and the processing circuitry 1406 may be configured to perform operations detailed in the above figures, diagrams, and flows.

Some embodiments are directed to an apparatus for a user equipment (UE) configured for operating in a fifth-generation (5G) new radio (NR) network comprising processing circuitry and memory.

In accordance with some embodiments, the communications circuitry 1402 may be arranged to contend for a wireless medium and configure frames or packets for communicating over the wireless medium. The communications circuitry 1402 may be arranged to transmit and receive signals. The communications circuitry 1402 may also include circuitry for modulation/demodulation, upconversion/downconversion, filtering, amplification, etc. In some embodiments, the processing circuitry 1406 of the communication device 1400 may include one or more processors. In other embodiments, two or more antennas 1401 may be coupled to the communications circuitry 1402 arranged for sending and receiving signals. The memory 1408 may store information for configuring the processing circuitry 1406 to perform operations for configuring and transmitting message frames and performing the various operations described herein. The memory 1408 may include any type of memory, including non-transitory memory, for storing information in a form readable by a machine (e.g., a computer). For example, the memory 1408 may include a computer-readable storage device, read-only memory (ROM), random-access memory (RAM), magnetic disk storage media, optical storage media, flash-memory devices and other storage devices and media.

In some embodiments, the communication device 1400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication device 1400 may include one or more antennas 1401. The antennas 1401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the communication device 1400 may include one or more of a keyboard, a display, a non-volatile memory port, multiple antennas, a graphics processor, an application processor, speakers, and other mobile device elements. The display may be an LCD screen including a touch screen.

Although the communication device 1400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication device 1400 may refer to one or more processes operating on one or more processing elements.

The following describes embodiments for a RedCap UE.

Maximum device bandwidth: A baseline NR device is required to support 100 MHz in frequency range 1 (FR1), and 200 MHz in FR2, for transmission and reception. For RedCap, these requirements are reduced to 20 MHz and 100 MHz, respectively. Such bandwidth reductions however still allow all the physical channels and signals specified for initial acquisition to be readily reusable for RedCap UEs, therefore minimizing the impact on network and device deployment when introducing RedCap to support the new use cases.

Minimum number of device receive branches: The number of receive branches is related to the number of receive antennas. Reducing the number of receive branches therefore results in a reduction in the number of receive antennas and cost saving. The requirements on the minimum number of receive branches depends on frequency bands. Some frequency bands (most of the FR1 frequency-division duplex (FDD) bands, a handful of FR1 time-division duplex (TDD) bands, and all FR2 bands) require a baseline NR device to be equipped with two receive branches, whereas some other frequency bands, mostly in the FR1 TDD bands, require the device to be equipped with four receive branches.

For the bands where a baseline NR device is required to be equipped with a minimum of two receive branches, a RedCap UE is only required to have one receive branch. For the bands where a baseline NR device is required to be equipped with a minimum of four receive branches, it is yet to be decided whether a RedCap UE is required to have one or two receive branches.

Maximum number of downlink MIMO layers: The maximum number of downlink MIMO layers for a RedCap UE is the same as the number of receive branches it supports. This is a reduction compared to the requirements for a baseline device.

Maximum downlink modulation order: A baseline NR device is required to support 256QAM in the downlink in FR1. For a RedCap UE, the support of downlink 256QAM is optional. For FR1 uplink and FR2, both downlink and uplink, a RedCap UE is required to support 64QAM, same as the requirement for a baseline device.

Duplex operation: Regarding duplex operations, the only relaxation is for operations in FDD bands. A baseline NR device is required to support a full duplex (FD) operation in an FDD band, i.e., transmitting and receiving on different frequencies at the same time. A typical full-duplex device incorporates a duplex filter to isolate the interference between the device's transmit and receive paths. In practice, the same device may need to support multiple FDD bands; therefore, multiple duplex filters may be needed to support the FD-FDD operation.

For a RedCap UE, the support of FD-FDD is optional, i.e., it is not required to receive in the downlink frequency while transmitting in the uplink frequency, and vice versa. Such a duplex operation is referred to as half duplex FDD (HD-FDD). HD-FDD obviates the need for duplex filters. Instead, a switch can be used to select the transmitter or receive to connect to the antenna. As a switch is less expensive than multiple duplexers, cost savings are achieved.

Furthermore, a RedCap UE is expected to operate in a single band at a time and will not support carrier aggregation and dual connectivity.

### Examples (Set 1)

1. A system and method to receive multiple overlapped DL channels for UE with reduced bandwidth comprising,
   Received by a UE, the configuration on the DL channels/signals

### Detected by a UE, a Physical Downlink Control Channel (PDCCH)

Received by the UE, the PDSCH(s) scheduled by the PDCCH(s) and other DL channel/signals
2. The system and method of example 1, the UE is expected to decode two PDSCHs each scheduled with SI-RNTI, P-RNTI, RA-RNTI or TC-RNTI, subjected to one of the following conditions,
   the total number of allocated PRBs of the two PDSCHs in any OFDM symbol does not exceed N_{BW} PRBs.
   the two PDSCHs are allocated within N_{BW} localized PRBs.
   the total number of allocated REs of the two PDSCHs in a slot does not exceed a threshold.
3. The system and method of example 1, the UE does not expect that the sum of the TBSs of multiple PDSCH(s) scheduled with SI-RNTI, P-RNTI, RA-RNTI or TC-RNTI in the same slot is larger than a threshold
4. The system and method of example 1, the UE does not expect that the sum of multiple PDSCH(s) scheduled with SI-RNTI, P-RNTI, RA-RNTI or TC-RNTI in the same slot exceeds a maximum data rate.
5. The system and method of example 1, the UE does not expect to decode more than one PDSCH scheduled with SI-RNTI, P-RNTI, RA-RNTI or TC-RNTI in a OFDM symbol or a slot
6. The system and method of example 1, the UE is expected to decode a PDSCH scheduled with C-RNTI, MCS-C-RNTI, or CS-RNTI and, for P-RNTI triggered or autonomous SI acquisition, another PDSCH scheduled with SI-RNTI in the same slot, subjected to one of the following conditions,
   the total number of allocated PRBs of the two PDSCHs in any OFDM symbol does not exceed N_{BW} PRBs.
   the two PDSCHs are allocated within N_{BW} localized PRBs.
   the total number of allocated REs of the two PDSCHs in a slot does not exceed a threshold.
7. The system and method of example 6, the UE only receive a subset of PRBs of the PDSCH scheduled with C-RNTI, MCS-C-RNTI, or CS-RNTI in the OFDM symbol
8. The system and method of example 1, the UE does not expect that the sum of the TBS of a PDSCH scheduled with C-RNTI, MCS-C-RNTI, or CS-RNTI and the TBS of another PDSCH scheduled with SI-RNTI in the same slot for P-RNTI triggered or autonomous SI acquisition is larger than a threshold
9. The system and method of example 1, the UE does not expect that the sum of the TBS of a PDSCH scheduled with C-RNTI, MCS-C-RNTI, or CS-RNTI and the TBS of another PDSCH scheduled with SI-RNTI in the same slot for P-RNTI triggered or autonomous SI acquisition exceeds a maximum data rate.
10. The system and method of example 1, the UE does not expect to decode a PDSCH scheduled with C-RNTI, MCS-C-RNTI, or CS-RNTI and, for P-RNTI triggered or autonomous SI acquisition, another PDSCH scheduled with SI-RNTI in a OFDM symbol or a slot.
11. The system and method of example 1, the UE does not expect to be scheduled or configured to process more than X ongoing PDSCH receptions and more than Y ongoing PUSCH transmissions, X, Y are predefined
12. The system and method of example 1, for the PDSCH and the one or multiple channels/signals, the UE is not capable of receiving more than N_{BW} PRBs in any OFDM symbol in a slot.
13. The system and method of example 1, for the PDSCH and the one or multiple channels/signals, the UE is not capable of receiving more than a maximum number of REs in a slot.

### Examples (set 2)

1. A system and method to enhance the transmission in separate initial BWP for UE with reduced bandwidth comprising,
   Detected by a UE, a Physical Downlink Control Channel (PDCCH) Received or transmitted by the UE, the PDSCH or PUSCH scheduled by the PDCCH
2. The system and method of example 1, a frequency region of up to N_{BW} consecutive PRBs is identified first, then, the allocated frequency resource for DL/UL transmission is indicated within the identified frequency region, where N_{BW} is the maximum number of PRBs that is supported by the UE.
3. The system and method of example 2, the frequency region for DL/UL transmission is predefined, or determined by a fixed rule with respect to the CORESET #0, or semi-statically configured by high layer signaling, or activated by MAC CE.
4. The system and method of example 2, the frequency resource for DL/UL transmission is dynamically allocated within the DL/UL BWP, subjected to a limitation that the allocated PRBs must be within localized N_{BW} PRBs.
5. The system and method of example 4, a frequency region and the allocated frequency resource within the frequency region are indicated by the header part and remaining part of the DFRA field
6. The system and method of example 5, the boundary of the RBG in the frequency region is aligned with the boundary of the RBG of the DL/UL BWP
7. The system and method of example 4, the frequency resource is indicated directly within the BWP
8. The system and method of example 2, a frequency region of up to N_{BW} distributed PRBs is identified first, then, the allocated frequency resource for DL/UL transmission is indicated within the identified frequency region, where N_{BW} is the maximum number of PRBs that is supported by the UE.
9. The system and method of example 8, the DL/UL BWP is divided into multiple combs and each comb is a frequency region.
10. The system and method of example 8, with a unit of X consecutive PRBs, a frequency region is a number equally spaced units in the DL/UL BWP.
11. The system and method of example 8, the frequency region for DL/UL transmission is predefined, or determined by a fixed rule with respect to the CORESET #0, or semi-statically configured by high layer signaling, or activated by MAC CE.
12. The system and method of example 8, the frequency resource for DL/UL transmission is dynamically allocated within the DL/UL BWP, subjected to a limitation that the allocated PRBs must be within N_{BW} PRBs.
13. The system and method of example 12, a frequency region and the allocated frequency resource within the frequency region are indicated by the header part and remaining part of the DFRA field
14. The system and method of example 13, the header for frequency region indication is a separate field in the DCI format
15. The system and method of example 12, the frequency resource is indicated directly within the BWP
16. The system and method of example 2-7, the frequency hopping across different frequency regions is supported.
17. The system and method of example 16, the UE expects that each hop of the PDSCH or PUSCH transmission is located within a frequency region
18. The system and method of example 16, the UE expects that each hop of the PDSCH or PUSCH transmission is located within a frequency region and the same FDRA as the first hop applies in each frequency region.
19. The system and method of example 16, the UE expects that each hop of the PDSCH or PUSCH transmission is located within a frequency region and the mirror of the FDRA is applied within the frequency region of every second hop.
20. The system and method of example 16, the UE expects that the first hop of the PDSCH or PUSCH transmission must be located within a frequency region, while other hops are allowed to cross the boundary of two frequency regions.
21. The system and method of example 16, for a PDSCH or PUSCH transmission with repetitions, multiple values of RB_{offset} are supported.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1-20. (canceled)

21. An apparatus for a user equipment (UE) configured for operating in a fifth generation (5G) new radio (NR) network, the apparatus comprising: processing circuitry; and memory,
wherein the UE is a reduced-capacity (RedCap) UE (RedCap UE) having a reduced peak data rate and a reduced bandwidth in frequency range 1 (FR1),
wherein the processing circuitry is configured to:
decode signalling that schedules a number of physical downlink shared channels (PDSCHs) per slot;
wherein if a total number of physical resource blocks (PRBs) for the scheduled PDSCHs exceed a predetermined value and the scheduled PDSCHs partially or fully overlap in time in non-overlapping PRBs, the processing circuitry is configured to:
prioritize decoding of one of the scheduled PDSCHs.

22. The apparatus of claim 21, wherein the predetermined value is twenty-five (25) PRBs for a subcarrier spacing (SCS) of 15 kHz.

23. The apparatus of claim 22, wherein the reduced bandwidth in FR1 is 20 MHz.

24. The apparatus of claim 23, wherein the processing circuitry is configured to prioritize decoding of one of the scheduled PDSCHs based on a Radio Network Temporary Identifier (RNTI) that scheduled the PDSCHs when the total number of PRBs exceed the predetermined value.

25. The apparatus of claim 24, wherein during Paging Radio Network Temporary Identifier (P-RNTI) triggered system information (SI) acquisition, when the total number of PRBs for the scheduled PDSCHs exceed the predetermined value, the processing circuitry is configured to prioritize the decoding of a PDSCH that is scheduled with a SI-RNTI over a PDSCH that is scheduled with a Cell-RNTI (C-RNTI), a Modulation Coding Scheme C-RNTI (MCS-C-RNTI), or a Configured Scheduling RNTI (CS-RNTI).

26. The apparatus of claim 24, wherein the processing circuitry is further configured to decode more than one of the scheduled PDSCHs when the total number of PRBs does not exceed the predetermined value when the scheduled PDSCHs partially or fully overlap in time in non-overlapping PRBs.

27. The apparatus of claim 24, wherein the processing circuitry is configured for a relaxed processing timeline for the scheduled PDSCHs when the total number of PRBs exceeds the predetermined value for the SCS of 15 kHz.

28. The apparatus of claim 24, wherein the number of PDSCHs that are scheduled per slot are scheduled per component carrier.

29. The apparatus of claim 24, wherein during Paging Radio Network Temporary Identifier (P-RNTI) triggered system information (SI) acquisition, when the total number of PRBs for the scheduled PDSCHs exceed the predetermined value, the processing circuitry is configured to decode a PDSCH that is scheduled with a SI-RNTI and skip decoding of a PDSCH that is scheduled with one of a Cell-RNTI (C-RNTI), a Modulation Coding Scheme C-RNTI (MCS-C-RNTI), and a Configured Scheduling RNTI (CS-RNTI).

30. The apparatus of claim 24, wherein during Paging Radio Network Temporary Identifier (P-RNTI) triggered system information (SI) acquisition, when the total number of PRBs for the scheduled PDSCHs exceed the predetermined value, the processing circuitry is configured to decode a PDSCH that is only scheduled with a SI-RNTI.

31. A non-transitory computer-readable storage medium that stores instructions for execution by processing circuitry OF a user equipment (UE) configured for operating in a fifth generation (5G) new radio (NR) network, the apparatus comprising: processing circuitry; and memory,
wherein the UE is a reduced-capacity (RedCap) UE (RedCap UE) having a reduced peak data rate and a reduced bandwidth in frequency range 1 (FR1),
wherein the processing circuitry is configured to:
decode signalling that schedules a number of physical downlink shared channels (PDSCHs) per slot;
wherein if a total number of physical resource blocks (PRBs) for the scheduled PDSCHs exceed a predetermined value and the scheduled PDSCHs partially or fully overlap in time in non-overlapping PRBs, the processing circuitry is configured to:
prioritize decoding of one of the scheduled PDSCHs.

32. The non-transitory computer-readable storage medium of claim 31, wherein the predetermined value is twenty-five (25) PRBs for a subcarrier spacing (SCS) of 15 kHz.

33. The non-transitory computer-readable storage medium of claim 32, wherein the reduced bandwidth in FR1 is 20 MHz.

34. The non-transitory computer-readable storage medium of claim 33, wherein the processing circuitry is configured to prioritize decoding of one of the scheduled PDSCHs based on a Radio Network Temporary Identifier (RNTI) that scheduled the PDSCHs when the total number of PRBs exceed the predetermined value.

35. The non-transitory computer-readable storage medium of claim 34, wherein during Paging Radio Network Temporary Identifier (P-RNTI) triggered system information (SI) acquisition, when the total number of PRBs for the scheduled PDSCHs exceed the predetermined value, the processing circuitry is configured to prioritize the decoding of a PDSCH that is scheduled with a SI-RNTI over a PDSCH that is scheduled with a Cell-RNTI (C-RNTI), a Modulation Coding Scheme C-RNTI (MCS-C-RNTI), or a Configured Scheduling RNTI (CS-RNTI).

36. The non-transitory computer-readable storage medium of claim 34, wherein the processing circuitry is further configured to decode more than one of the scheduled PDSCHs when the total number of PRBs does not exceed the predetermined value when the scheduled PDSCHs partially or fully overlap in time in non-overlapping PRBs.

37. The non-transitory computer-readable storage medium of claim 34, wherein the processing circuitry is configured for a relaxed processing timeline for the scheduled PDSCHs when the total number of PRBs exceeds the predetermined value for the SCS of 15 kHz.

38. The non-transitory computer-readable storage medium of claim 34, wherein the number of PDSCHs that are scheduled per slot are scheduled per component carrier.

39. An apparatus of a generation Node B (gNB) configured for operating in a fifth generation (5G) new radio (NR) network, the apparatus comprising: processing circuitry; and memory,
wherein for a reduced-capacity user equipment (RedCap UE) having a reduced peak data rate and a reduced bandwidth in frequency range 1 (FR1), the processing circuitry is configured to:
encode signalling that schedules the UE for a number of physical downlink shared channels (PDSCHs) per slot;
wherein if a total number of physical resource blocks (PRBs) for the scheduled PDSCHs exceed a predetermined value and the scheduled PDSCHs partially or fully overlap in time in non-overlapping PRBs, the UE prioritizes decoding of one of the scheduled PDSCHs based on a Radio Network Temporary Identifier (RNTI) that scheduled the PDSCHs when the total number of PRBs exceed the predetermined value.

40. The apparatus of claim 39, wherein the predetermined value is twenty-five (25) PRBs for a subcarrier spacing (SCS) of 15 kHz, and
wherein the reduced bandwidth in FR1 is 20 MHz.
